(19) United States
(12) Patent Application Publication
(10) Pub. No.: US 2026/0118649 A1
(43) Pub. Date: Apr. 30, 2026

(54) ZOOM LENS AND IMAGE PICKUP APPARATUS

(71) Applicant: CANON KABUSHIKI KAISHA, Tokyo (JP)

(72) Inventors: Yonghee LEE, Saitama (JP); Masatsugu NAKANO, Tochigi (JP)

(21) Appl. No.: 19/321,349

(22) Filed: Sep. 8, 2025

(30) Foreign Application Priority Data
Oct. 30, 2024 (JP) 2024-190407

(51) Int. Cl. G02B 15/14; G02B 15/20

(52) U.S. Cl. CPC G02B 15/1461; G02B 15/20

(57) ABSTRACT

A zoom lens includes, in order from an object side to an image side, a first lens unit with positive refractive power that does not move for zooming, three or more movable lens units that move for zooming, and an N-th lens unit with positive refractive power as a final lens unit. Each distance between adjacent lens units changes during zooming. The movable lens units include an (N−1)-th lens unit with positive refractive power, an (N−2)-th lens unit with negative refractive power, and one or more V lens units. The first lens unit includes a focus sub-lens unit. The (N−1)-th lens unit is located closer to an image plane at a telephoto end than at a wide-angle end. The N-th lens unit includes a front sub-lens unit and a rear sub-lens unit arranged in this order from the object side via a widest air gap. A predetermined inequality is satisfied.

### BACKGROUND

### Field of the Technology

The aspect of the disclosure relates to one or more embodiments of a zoom lens for imaging.

### Description of the Related Art

Zoom lenses are demanded to have a reduced size, a wide angle of view, and high optical performance. Japanese Patent Application Laid-Open No. 2022-022580 discloses a zoom lens that includes, in order from the object side to the image side, a first lens unit with positive refractive power that does not move for zooming, a plurality of lens units that move for zooming, and a rear lens unit with positive refractive power that does not move for zooming.

### SUMMARY

One or more embodiments of a zoom lens according to one or more aspects of the disclosure may include a plurality of lens units. The plurality of lens units may include, in order from an object side to an image side, a first lens unit with positive refractive power that does not move for zooming, three or more movable lens units that move for zooming, and an N-th lens unit with positive refractive power as a final lens unit. Each distance between adjacent lens units changes during zooming. The three or more movable lens units include an (N−1)-th lens unit with positive refractive power, an (N−2)-th lens unit with negative refractive power, and one or more V lens units. The first lens unit includes a focus sub-lens unit that moves for focusing. The (N−1)-th lens unit is located closer to an image plane at a telephoto end than at a wide-angle end. The N-th lens unit includes a front sub-lens unit and a rear sub-lens unit arranged in this order from the object side via a widest air gap in the N-th lens unit. The following inequalities are satisfied:

$$- 2 \text{.2} \leq \sum ( f 1 / fVi ) \leq - 0.4$$

$$2. \leq β ( N - 1 ) w \leq 18.5$$

$$0.3 \leq LE / LR \leq 0.7$$

$$- 0.8 \leq β rr \leq 0. 8$$

where f1 is a focal length of the first lens unit, fVi is a focal length of an i-th movable lens unit counted from the object side among the one or more V lens units, Σ(f1/fVi) is a sum of f1/fVi, β(N−1)w is a lateral magnification of the (N−1)-th lens unit at the wide-angle end, LE is a length on an optical axis of the widest air gap in the N-th lens unit, LR is a length on the optical axis from a surface closest to an object of the N-th lens unit to a surface closest to the image plane of the N-th lens unit, and Brr is a lateral magnification of the rear sub-lens unit at the wide-angle end. Alternatively, the following inequality is satisfied:

$$2. \leq β ( N - 1 ) w \leq 18.5$$

where β(N−1)w is a lateral magnification of the (N−1)-th lens unit at the wide-angle end. One or more image pickup apparatuses may include one or more zoom lenses in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a zoom lens according to Example 1 at a wide-angle end.

FIGS. 2A and 2B are aberration diagrams of the zoom lens according to Example 1 at the wide-angle end and a telephoto end, respectively.

FIG. 3 is a sectional view of a zoom lens according to Example 2 at a wide-angle end.

FIGS. 4A and 4B are aberration diagrams of the zoom lens according to Example 2 at the wide-angle end and a telephoto end, respectively.

FIG. 5 is a sectional view of a zoom lens according to Example 3 at a wide-angle end.

FIGS. 6A and 6B are aberration diagrams of the zoom lens according to Example 3 at the wide-angle end and a telephoto end, respectively.

FIG. 7 is a sectional view of a zoom lens according to Example 4 at a wide-angle end.

FIGS. 8A and 8B are aberration diagrams of the zoom lens according to Example 4 at the wide-angle end and a telephoto end, respectively.

FIG. 9 is a sectional view of a zoom lens according to Example 5 at a wide-angle end.

FIGS. 10A and 10B are aberration diagrams of the zoom lens according to Example 5 at the wide-angle end and a telephoto end, respectively.

FIG. 11 is a sectional view of a zoom lens according to Example 6 at a wide-angle end.

FIGS. 12A and 12B are aberration diagrams of the zoom lens according to Example 6 at the wide-angle end and a telephoto end, respectively.

FIG. 13 is a sectional view of a zoom lens according to Example 7 at a wide-angle end.

FIGS. 14A and 14B are aberration diagrams of the zoom lens according to Example 7 at the wide-angle end and a telephoto end, respectively.

FIG. 15 illustrates an image pickup apparatus using any one of the zoom lenses according to Examples 1 to 7.

### DESCRIPTION OF THE EMBODIMENTS

A description will be given of examples according to the disclosure with reference to the drawings. First, before Examples 1 to 7 are described, matters common to each example will be described.

A zoom lens according to each example is used for a variety of image pickup apparatuses such as cinema cameras, broadcasting cameras, video cameras, surveillance cameras, digital still cameras, and film-based cameras. In a zoom lens, a lens unit is a group of one or more lenses that may or may not move as a unit during magnification variation (zooming) between the wide-angle end and the telephoto end. In other words, each distance between adjacent lens units changes during zooming. The lens unit may include an aperture stop (diaphragm). The wide-angle end and the telephoto end respectively indicate zoom states of the maximum angle of view (shortest focal length) and the minimum angle of view (longest focal length) when the lens unit that moves during zooming is located at both ends of the mechanically or controllably movable range on the optical axis.

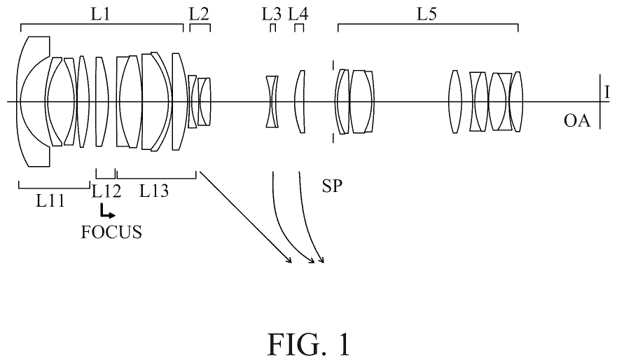

FIGS. 1, 3, 5, 7, 9, 11, and 13 respectively illustrate cross sections of zoom lenses according to Examples 1 to 7 in an in-focus state on an object at infinity (referred to as “in an in-focus state at infinity” hereinafter) at the wide-angle end. In each figure, a left side is an object side (front side) and a right side is an image side (rear side). OA indicates an optical axis of the zoom lens.

Li is an i-th (i=1, 2, . . . ) lens unit counted from the object side, and L1m is an m-th (m=1, 2, . . . ) sub-lens unit counted from the object side in the first lens unit L1. A sub-lens unit is a group of one or more lenses that move or do not move integrally during focusing. SP is an aperture stop (diaphragm), and I is an image plane. An imaging surface (light receiving surface) of the image sensor in the image pickup apparatus and a film surface (photosensitive surface) of the silver film are located on the image plane I.

In each figure, an arrow is attached below the lens unit that moves during zooming to illustrate a moving locus (trajectory) of that lens unit during zooming from the wide-angle end to the telephoto end. An arrow labeled FOCUS is attached below the sub-lens unit of the first lens unit L1 that moves during focusing to show the moving direction of that sub-lens unit during focusing from infinity to a close distance.

The zoom lens according to each example includes a plurality of lens units. The plurality of lens units include, in order from the object side to the image side, a first lens unit L1 with positive refractive power that does not move for zooming, three or more movable lens units L2 to L4 (or L5) that move for zooming, and an N-th lens unit LN (N=5 or 6) as a final lens unit with positive refractive power that does not move for zooming. The three or more movable lens units include, in order from the image side to the object side, an (N−1)-th lens unit with positive refractive power, an (N−2)-th lens unit with negative refractive power, and one or more V lens units.

The first lens unit L1 further includes a focus sub-lens unit that moves for focusing. The (N−1)-th lens unit is located closer to the image plane at the telephoto end than at the wide-angle end. The N-th lens unit includes a front sub-lens unit and a rear sub-lens unit arranged in this order from the object side to the image side via the widest air gap.

The zoom lens according to each example may satisfy at least one of the following inequalities (1) to (4):

$$- 2 \text{.2} \leq \sum ( f 1 / fVi ) \leq - 0.4 \qquad ( 1 )$$

$$2. \leq β ( N - 1 ) w \leq 18.5 \qquad ( 2 )$$

$$0.3 \leq LE / LR \leq 0.7 \qquad ( 3 )$$

$$- 0.8 \leq β rr \leq 0. 8 \qquad ( 4 )$$

where f1 is a focal length of the first lens unit L1, fVi is a focal length of an i-th movable lens unit counted from the object side among the one or more V lens units, Σ is the sum of f1/fVi, β(N−1)w is a lateral magnification of the (N−1)-th lens unit at the wide-angle end, LE is a length on the optical axis with the widest air gap in the N-th lens unit, LR is a length on the optical axis from a surface closest to the object of the N-th lens unit to a surface closest to the image plane of the N-th lens unit, and Brr is a lateral magnification of the rear sub-lens unit at the wide-angle end.

Inequality (1) defines a proper relationship between the combined focal length of the first lens unit L1 and one or more V lens units that contribute significantly to acquiring the zoom ratio among the three or more movable lens units. Satisfying inequality (1) can achieve a refractive power arrangement that is beneficial to achieving a high zoom magnification and a reduced size and weight of the zoom lens. In a case where Σ(f1/fVi) becomes higher than the upper limit of inequality (1), the combined refractive power of the V lens unit V becomes too weak relative to the refractive power of the first lens unit L1, and it becomes difficult to achieve a high zoom magnification of the zoom lens. In a case where Σ(f1/fVi) becomes lower than the lower limit of inequality (1), the combined refractive power of the V lens unit V and thus the aberration fluctuation during zooming increase, or in a case where an attempt is made to suppress the aberration fluctuation, it becomes difficult to achieve a reduced size and weight of zoom lens.

The lower limit of inequality (1) may be set to −2.0, −1.8, or −1.7, and the upper limit of inequality (1) may be set to −0.5, −0.6, or −0.65.

Inequality (2) defines a proper range of the lateral magnification of the (N−1)-th lens unit at the wide-angle end. Satisfying inequality (2) can achieve an arrangement beneficial to a high zoom magnification. In a case where β(N−1)w becomes higher than the upper limit of inequality (2), a light beam emitted from the (N−1)-th lens unit becomes closer to a parallel light beam and it becomes difficult to obtain the magnification increasing effect during zooming. In a case where β(N−1)w becomes lower than the lower limit of inequality (2), the light beam emitted from the (N−1)-th lens unit becomes more divergent, the size of the final lens unit increases, and it becomes difficult to reduce the size of the zoom lens.

The lower limit of inequality (2) may be set to 2.4, 2.6 or 2.8, and the upper limit of inequality (2) may be set to 18.0, 17.0 or 16.0.

Inequality (3) defines a proper condition under which an optical unit such as an extender can be inserted into and removed from the widest air gap in the N-th lens unit. Satisfying inequality (3) can achieve a zoom lens that allows the optical unit to be inserted and removed. In a case where LE/LR becomes higher than the upper limit of inequality (3), the gap between the front sub-lens unit and the rear sub-lens unit in the final lens unit and thus the size of the zoom lens increase. In a case where LE/LR becomes lower than the lower limit of inequality (3), sufficient space cannot be secured for inserting and removing the optical unit.

The lower limit of inequality (3) may be set to 0.31, 0.32 or 0.33, and the upper limit of inequality (3) may be set to 0.65, 0.6 or 0.55.

Inequality (4) defines a proper range of the lateral magnification of the rear sub-lens unit in the final lens unit at the wide-angle end. Satisfying inequality (4) can achieve a zoom lens that has a reduced size and weight and proper back focus. In a case where Brr becomes higher than the upper limit of inequality (4), it becomes difficult to secure the back focus. In a case where Brr becomes lower than the lower limit of inequality (4), a light ray with a large divergence angle enters the rear sub-lens unit, and the size of the final lens unit increases.

The lower limit of inequality (4) may be set to −0.65, −0.5 or −0.4, and the upper limit of inequality (4) may be set to 0.65, 0.5 or 0.4.

Satisfying the above configuration and inequalities can provide a zoom lens that has a reduced size, a wide angle of view, high optical performance, and a proper angle of light incidence on the image plane.

The zoom lens according to each example may satisfy at least one of the following inequalities (5) to (9):

$$1. 0 \leq β ( N - 1 ) t / β ( N - 1 ) w \leq 1.2 \qquad ( 5 )$$

$$2. \leq ( f 1 + bok 1 ) / f 1 \leq 5. \qquad ( 6 )$$

$$- 3. \leq \sum ( f ( N - 1 ) / fVi ) \leq - 0.5 \qquad ( 7 )$$

$$0. < Lm / L \leq 0.3 \qquad ( 8 )$$

$$1. 0 \leq f 1 / fw \leq 10.0 \qquad ( 9 )$$

In inequalities (5) to (9), β(N−1)t is a lateral magnification of the (N−1)-th lens unit at the telephoto end. bok1 is a distance on the optical axis from a surface closest to the image plane of the first lens unit L1 to the rear principal point of the first lens unit, where a direction from the object side to the image side is positive. f(N−1) is a focal length of the (N−1)-th lens unit. Σ(f(N−1)/fVi) is the sum of f(N−1)/fVi. Lm is a moving amount from the object side to the image side of the lens unit with the largest negative refractive power among the one or more V lens units during zooming from the wide-angle end to the telephoto end. A moving amount of a lens unit is a difference between a position of that lens unit at the wide-angle end and a position of that lens unit at the telephoto end, and does not include a reciprocating amount, and is considered positive in a case where the lens unit is located closer to the image side at the telephoto end than at the wide-angle end. L is a length on the optical axis from a surface closest to the object of the first lens unit L1 to a surface closest to the image plane of the N-th lens unit. fw is a focal length of the zoom lens at the wide-angle end.

Inequality (5) defines a proper range of a zoom ratio β(N−1)t/β(N−1)w of the (N−1)-th lens unit. In a case where the zoom ratio becomes higher than the upper limit of inequality (5), a moving amount of the (N−1)-th lens unit increases and it becomes difficult to reduce the size of the zoom lens. In a case where the zoom ratio becomes lower than the lower limit of inequality (5), the magnification is decreased in the (N−1)-th lens unit, and it becomes difficult to achieve a high zoom magnification of the zoom lens.

The lower limit of inequality (5) may be set to 1.005 or 1.01, and the upper limit of inequality (5) may be set to 1.19, 1.17, 1.15, or 1.10.

Inequality (6) defines a proper relationship between the distance on the optical axis from the surface closest to the image plane of the first lens unit L1 to the rear principal point of the first lens unit L1 and the focal length of the first lens unit L1 in order to achieve a zoom lens that has a wide angle of view and a reduced size and weight. In a case where (f1+bok1)/f1 becomes higher than the upper limit of inequality (6), the rear principal point of the first lens unit L1 will be located excessively toward the image side, the diameter of the lens disposed on the image side of the first lens unit L1 increases, and it becomes difficult to achieve a zoom lens that has a reduced size and weight. In a case where (f1+bok1)/f1 becomes lower than the lower limit of inequality (6), the focal length of the first lens unit L1 increases and it becomes difficult to achieve a wide angle of view.

The lower limit of inequality (6) may be set to 2.2, 2.3, or 2.4, and the upper limit of inequality (6) may be set to 4.5, 4.2, or 4.0.

Inequality (7) defines a proper relationship between the (N−1)-th lens unit and the combined focal length of the one or more V lens units. In a case where Σ(f(N−1)/fVi) becomes higher than the upper limit of inequality (7), the refractive power of the V lens unit, which contributes significantly to zooming, reduces, a moving amount of the V lens unit increases, and it becomes difficult to reduce the size of the zoom lens. In a case where Σ(f(N−1)/fVi) becomes lower than the lower limit of inequality (7), the refractive power of the (N−1)-th lens unit reduces, the lens diameter of the final lens unit increases, and it becomes difficult to reduce the size of the zoom lens.

The lower limit of inequality (7) may be set to −2.6, −2.4, or −2.2, and the upper limit of inequality (7) may be set to −0.8, −1.1, or −1.3.

Inequality (8) defines a proper relationship between the moving amount of the negative lens unit that contributes significantly to obtaining the zoom ratio among the three or more movable lens units, and the length from the surface closest to the object of the first lens unit L1 to the surface closest to the image plane of the N-th lens unit. In a case where Lm/L becomes higher than the upper limit of inequality (8), the moving amount of the negative lens unit during zooming increases and it becomes difficult to reduce the size of the zoom lens. In a case where Lm/L becomes lower than the lower limit of inequality (8), the moving amount of the negative lens unit during zooming reduces and it becomes difficult to increase the zoom ratio.

The lower limit of inequality (8) may be set to 0.05, 0.1, or 0.13, and the upper limit of inequality (8) may be set to 0.25, 0.22, or 0.2.

Inequality (9) defines a proper relationship between the focal length of the first lens unit L1 and the focal length of the zoom lens at the wide-angle end in order to obtain a zoom lens that has a reduced size, a wide angle of view, a high zoom ratio, and high optical performance. In a case where f1/fw becomes higher than the upper limit of inequality (9), the lens diameter of the first lens unit L1 increases and it becomes difficult to obtain a zoom lens that has a reduced size. In a case where f1/fw becomes lower than the lower limit of inequality (9), it becomes difficult to obtain a zoom lens with a wide angle of view and a high magnification variation ratio, or it becomes difficult to keep the aberration at the wide-angle end within the permissible range.

The lower limit of inequality (9) may be set to 1.5, 2.0, or 2.2, and the upper limit of inequality (9) may be set to 9.0, 8.0, 6.0, or 4.0.

The zoom lens according to each example may have at least one of the following configurations.

The first lens unit L1 may include a first sub-lens unit L11 with negative refractive power that does not move for focusing and is disposed closer to the object than the focus sub-lens unit that moves for focusing, a second sub-lens unit L12 with positive refractive power as the focus sub-lens unit, and a third sub-lens unit L13 with positive refractive power that does not move for focusing and is disposed closer to the image plane than the focus sub-lens unit. This configuration is beneficial to obtaining the zoom lens that has a wider angle.

The first lens unit L1 may have six or more lenses. This configuration enables good aberration correction and achieves high optical performance of the zoom lens.

The (N−1)-th lens unit may move monotonously toward the image side during zooming from the wide-angle end to the telephoto end. Moving in this manner can achieve the magnification increasing effect of the (N−1)-th lens unit over the entire zoom range.

The zoom lens according to each example will be specifically described below. After Example 7, numerical examples 1 to 7 corresponding to Examples 1 to 6 will be illustrated.

### Example 1

A zoom lens according to Example 1 (numerical example 1) illustrated in FIG. 1 includes, in order from the object side to the image side, a first lens unit L1 with positive refractive power, a second lens unit L2 with negative refractive power, a third lens unit L3 with negative refractive power, a fourth lens unit L4 with positive refractive power, an aperture stop SP, and a fifth lens unit L5 with positive refractive power. The first lens unit L1 does not move for zooming. The second lens unit L2, the third lens unit L3, and the fourth lens unit L4 constitute the three or more movable lens units that move for zooming. The fifth lens unit L5 is the final lens unit (N-th lens unit) for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power.

The second sub-lens unit L12 is a focus sub-lens unit that moves toward the image side during focusing from infinity to a close distance. The second lens unit L2 is a variator unit (V lens unit) that moves toward the image side during zooming from the wide-angle end to the telephoto end. The third lens unit ((N−2)-th lens unit) L3 and the fourth lens unit ((N−1)-th lens unit) L4 move toward the image side during zooming from the wide-angle end to the telephoto end. An optical unit such as an extender lens for focal length conversion may be inserted into the widest air gap in the fifth lens unit L5.

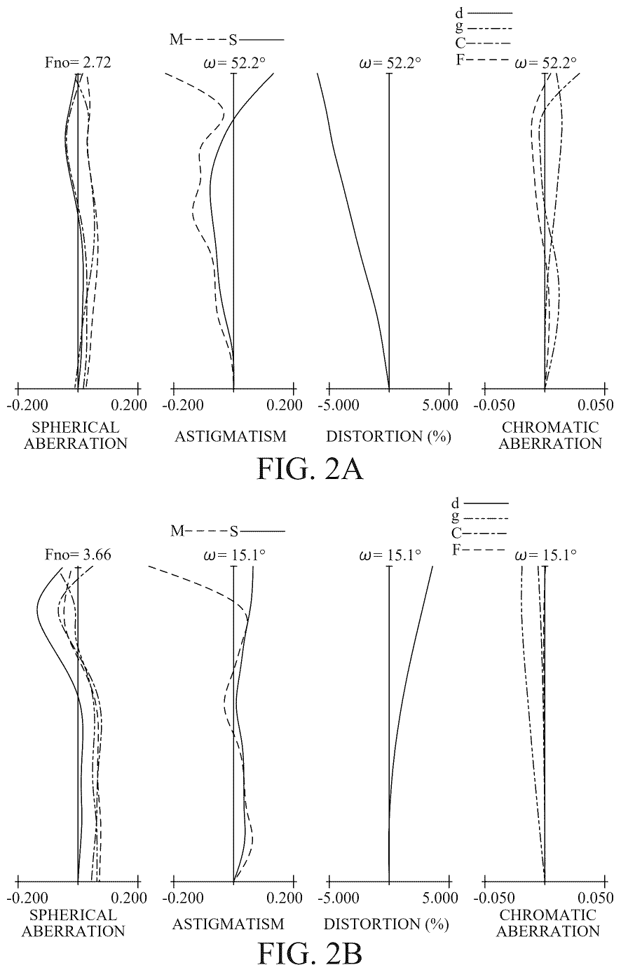

FIG. 2A illustrates longitudinal aberrations (spherical aberration, astigmatism, distortion, and chromatic aberration) of the zoom lens according to numerical example 1 in an in-focus state at infinity at a wide-angle end. FIG. 2B illustrates longitudinal aberration of the zoom lens according to numerical example 1 in the in-focus state at infinity at a telephoto end.

In the spherical aberration diagram, Fno indicates the F-number. A solid line indicates a spherical aberration amount for the d-line (wavelength 587.6 nm), and an alternate long and two short dashes line indicates a spherical aberration amount for the g-line (wavelength 435.8 nm). An alternate long and short dash line indicates a spherical aberration amount for the C-line (wavelength 656.3 nm), and a broken line indicates a spherical aberration amount for the F-line (wavelength 486.1 nm). In the astigmatism diagram, a solid line S indicates an astigmatism amount on a sagittal image plane, and a broken line M indicates an astigmatism amount on a meridional image plane. The distortion diagram illustrates a distortion amount for the d-line. The chromatic aberration diagram illustrates lateral chromatic aberration amounts for the g-line, C-line, and F-line. The astigmatism diagram and chromatic aberration diagram illustrate aberration amounts in a case where a central ray of a light beam at the aperture position is a principal ray. @ is a paraxial half angle of view (°). The spherical aberration is drawn on a scale of 0.2 mm, the astigmatism is drawn on a scale of 0.2 mm, the distortion is drawn on a scale of 5%, and the chromatic aberration is drawn on a scale of 0.05 mm. The above description of the aberration diagrams also applies to the aberration diagrams of other numerical examples.

### Example 2

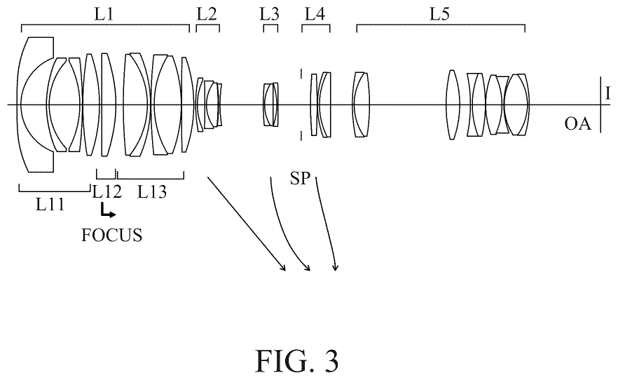

A zoom lens according to Example 2 (numerical example 2) illustrated in FIG. 3 includes, in order from the object side to the image side, a first lens unit L1 with positive refractive power, a second lens unit L2 with negative refractive power, a third lens unit L3 with negative refractive power, a fourth lens unit L4 with positive refractive power including an aperture stop SP, and a fifth lens unit L5 with positive refractive power. The first lens unit L1 does not move for zooming. The second lens unit L2, the third lens unit L3, and the fourth lens unit L4 constitute the three or more movable lens units that move for zooming. The fifth lens unit L5 is the final lens unit (N-th lens unit) for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 is a variator unit (V lens unit) that moves toward the image side during zooming from the wide-angle end to the telephoto end. The third lens unit ((N−2)-th lens unit) L3 and the fourth lens unit ((N−1)-th lens unit) L4 move toward the image side during zooming from the wide-angle end to the telephoto end. The aperture stop SP moves integrally with the fourth lens unit L4 during zooming. An optical unit such as an extender lens for focal length conversion may be inserted into the widest air gap in the fifth lens unit L5.

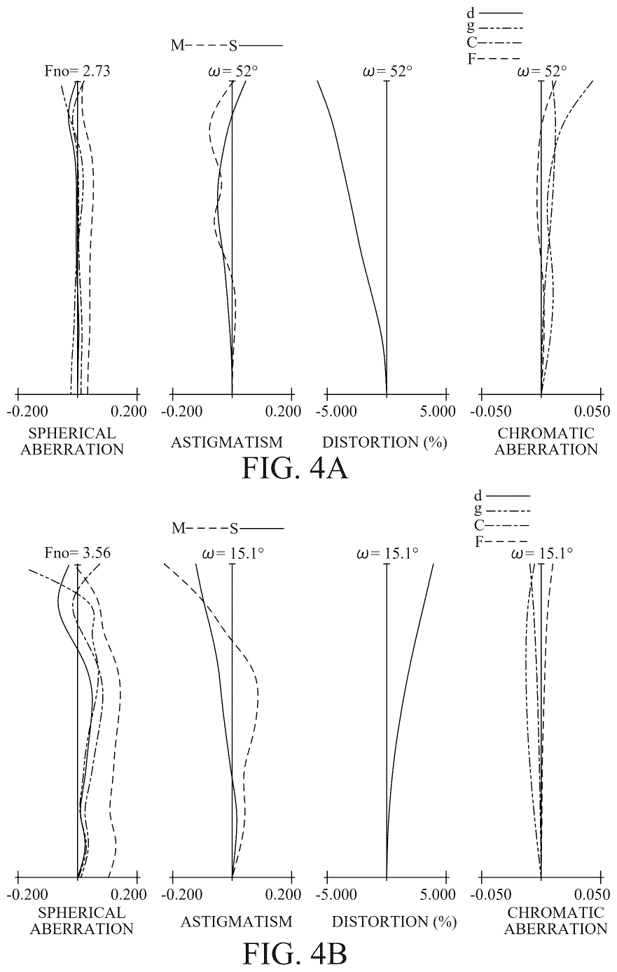

FIG. 4A illustrates longitudinal aberrations of the zoom lens according to numerical example 2 in an in-focus state at infinity at a wide-angle end. FIG. 4B illustrates longitudinal aberration of the zoom lens according to numerical example 2 in the in-focus state at infinity at a telephoto end.

### Example 3

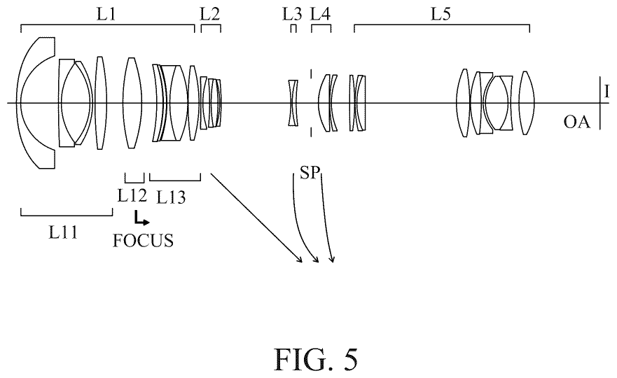

A zoom lens according to Example 3 (numerical example 3) illustrated in FIG. 5 includes, in order from the object side to the image side, a first lens unit L1 with positive refractive power, a second lens unit L2 with negative refractive power, a third lens unit L3 with negative refractive power, a fourth lens unit L4 with positive refractive power including an aperture stop SP, and a fifth lens unit L5 with positive refractive power. The first lens unit L1 does not move for zooming. The second lens unit L2, the third lens unit L3, and the fourth lens unit L4 constitute the three or more movable lens units that move for zooming. The fifth lens unit L5 is the final lens unit (N-th lens unit) for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 is a variator unit (V lens unit) that moves toward the image side during zooming from the wide-angle end to the telephoto end. The third lens unit ((N−2)-th lens unit) L3 and the fourth lens unit ((N−1)-th lens unit) L4 move toward the image side during zooming from the wide-angle end to the telephoto end. The aperture stop SP moves integrally with the fourth lens unit L4 during zooming. An optical unit such as an extender lens for focal length conversion may be inserted into the widest air gap in the fifth lens unit L5.

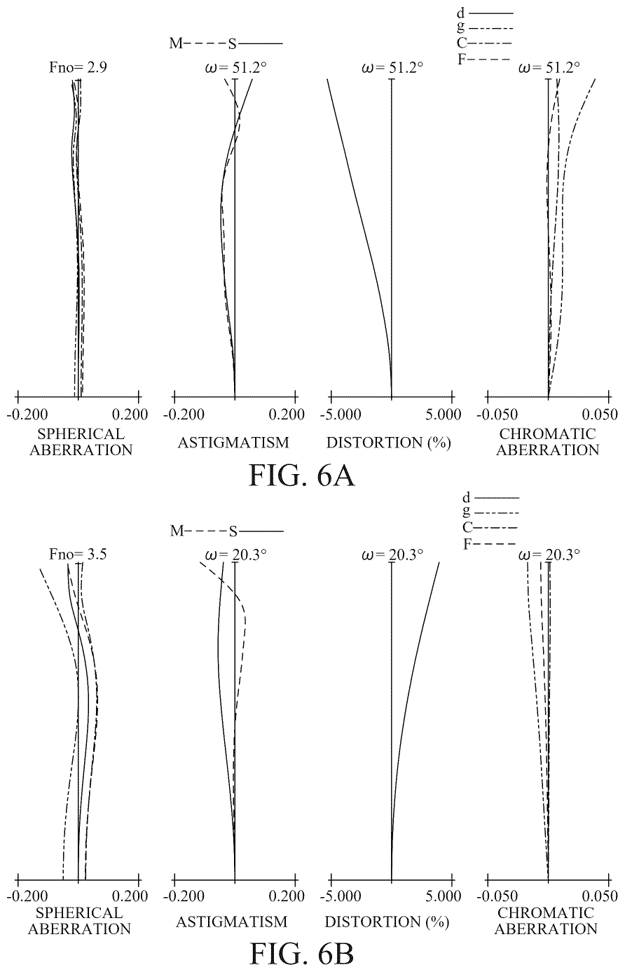

FIG. 6A illustrates longitudinal aberrations (spherical aberration, astigmatism, distortion, and chromatic aberration) of the zoom lens according to numerical example 3 in an in-focus state at infinity at a wide-angle end. FIG. 6B illustrates longitudinal aberrations of the zoom lens according to numerical example 3 in the in-focus state at infinity at a telephoto end.

### Example 4

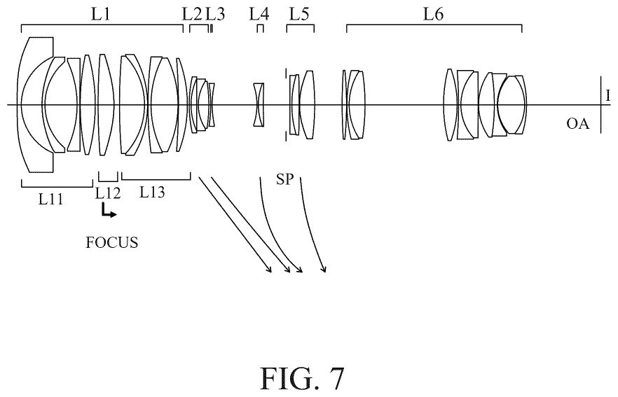

A zoom lens according to Example 4 (numerical example 4) illustrated in FIG. 7 includes, in order from the object side to the image side, a first lens unit L1 with positive refractive power, a second lens unit L2 with negative refractive power, a third lens unit L3 with negative refractive power, a fourth lens unit L4 with negative refractive power, a fifth lens unit L5 with positive refractive power including an aperture stop SP, and a sixth lens unit L6 with positive refractive power. The first lens unit L1 does not move for zooming. The second lens unit L2, the third lens unit L3, the fourth lens unit L4, and the fifth lens unit L5 constitute the three or more movable lens units that move for zooming. The sixth lens unit L6 is the final lens unit (N-th lens unit) for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side when focusing from infinity to a close distance.

The second lens unit L2 and the third lens unit L3 are variator units (V lens units) that move toward the image side during zooming from the wide-angle end to the telephoto end. The fourth lens unit ((N−2)-th lens unit) L4 and the fifth lens unit ((N−1)-th lens unit) L5 move toward the image side during zooming from the wide-angle end to the telephoto end. The aperture stop SP moves together with the fifth lens unit L5 during zooming. An optical unit such as an extender lens for focal length conversion may be inserted into the widest air gap in the sixth lens unit L6.

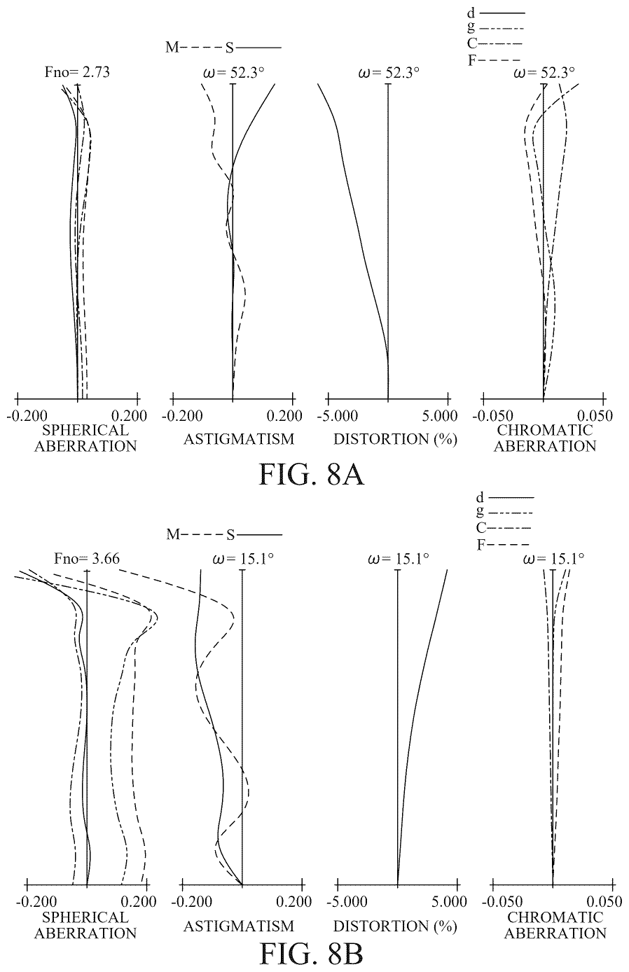

FIG. 8A illustrates longitudinal aberrations (spherical aberration, astigmatism, distortion, and chromatic aberration) of the zoom lens according to numerical example 4 in an in-focus state at infinity at a wide-angle end. FIG. 8B illustrates longitudinal aberrations of the zoom lens according to numerical example 4 in the in-focus state at infinity at a telephoto end.

### Example 5

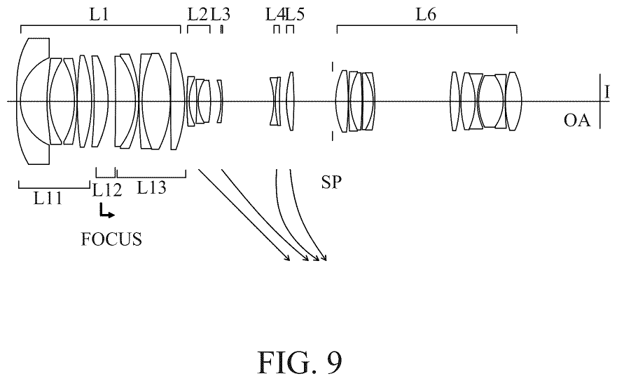

A zoom lens according to Example 5 (numerical example 5) illustrated in FIG. 9 includes, in order from the object side to the image side, a first lens unit L1 with positive refractive power, a second lens unit L2 with negative refractive power, a third lens unit L3 with negative refractive power, a fourth lens unit L4 with negative refractive power, a fifth lens unit L5 with positive refractive power, an aperture stop SP, and a sixth lens unit L6 with positive refractive power. The first lens unit L1 does not move for zooming. The second lens unit L2, the third lens unit L3, the fourth lens unit L4, and the fifth lens unit L5 constitute the three or more movable lens units that move for zooming. The sixth lens unit L6 is the final lens unit (N-th lens unit) for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 and the third lens unit L3 are variator units (V lens units) that move toward the image side during zooming from the wide-angle end to the telephoto end. The fourth lens unit ((N−2)-th lens unit) L4 and the fifth lens unit ((N−1)-th lens unit) L5 move toward the image side during zooming from the wide-angle end to the telephoto end. An optical unit such as an extender lens for focal length conversion may be inserted into the widest air gap in the sixth lens unit L6.

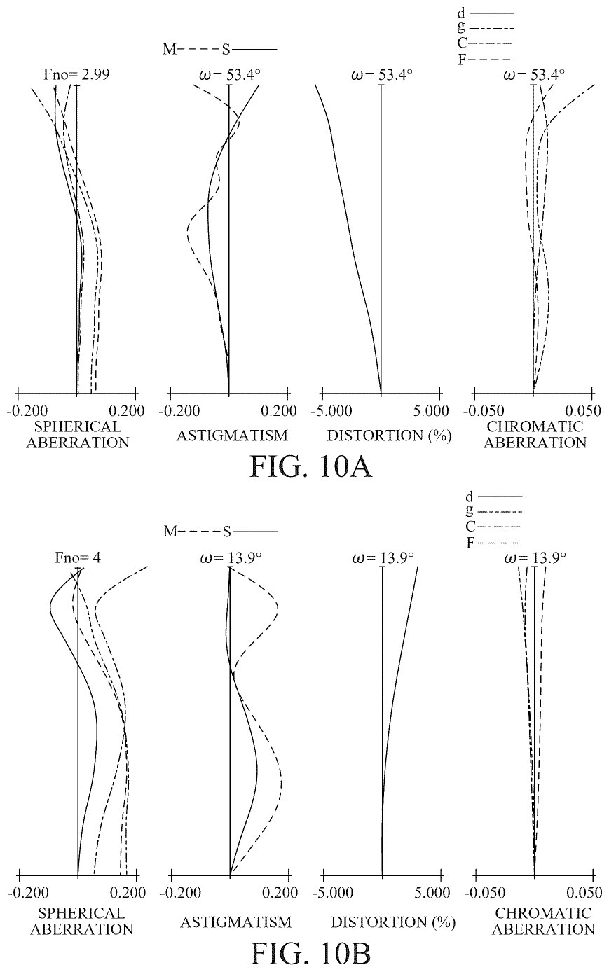

FIG. 10A illustrates longitudinal aberrations (spherical aberration, astigmatism, distortion, and chromatic aberration) of the zoom lens according to numerical example 5 in an in-focus state at infinity at a wide-angle end. FIG. 10B illustrates longitudinal aberrations of the zoom lens according to numerical example 5 in the in-focus state at infinity at a telephoto end.

### Example 6

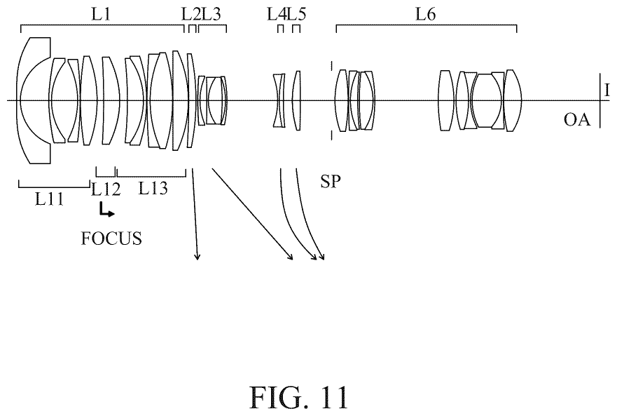

A zoom lens according to Example 6 (numerical example 6) illustrated in FIG. 11 includes, in order from the object side to the image side, a first lens unit L1 with positive refractive power, a second lens unit L2 with positive refractive power, a third lens unit L3 with negative refractive power, a fourth lens unit L4 with negative refractive power, a fifth lens unit L5 with positive refractive power, an aperture stop SP, and a sixth lens unit L6 with positive refractive power. The first lens unit L1 does not move for zooming. The second lens unit L2, the third lens unit L3, the fourth lens unit L4, and the fifth lens unit L5 constitute the three or more movable lens units that move for zooming. The sixth lens unit L6 is the final lens unit (N-th lens unit) for imaging and does not move for zooming.

The first lens unit L1 includes, in order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 and the third lens unit L3 are variator units (V lens units) that move toward the image side during zooming from the wide-angle end to the telephoto end. The fourth lens unit ((N−2)-th lens unit) L4 and the fifth lens unit ((N−1)-th lens unit) L5 move toward the image side during zooming from the wide-angle end to the telephoto end. An optical unit such as an extender lens for focal length conversion may be inserted into the widest air gap in the sixth lens unit L6.

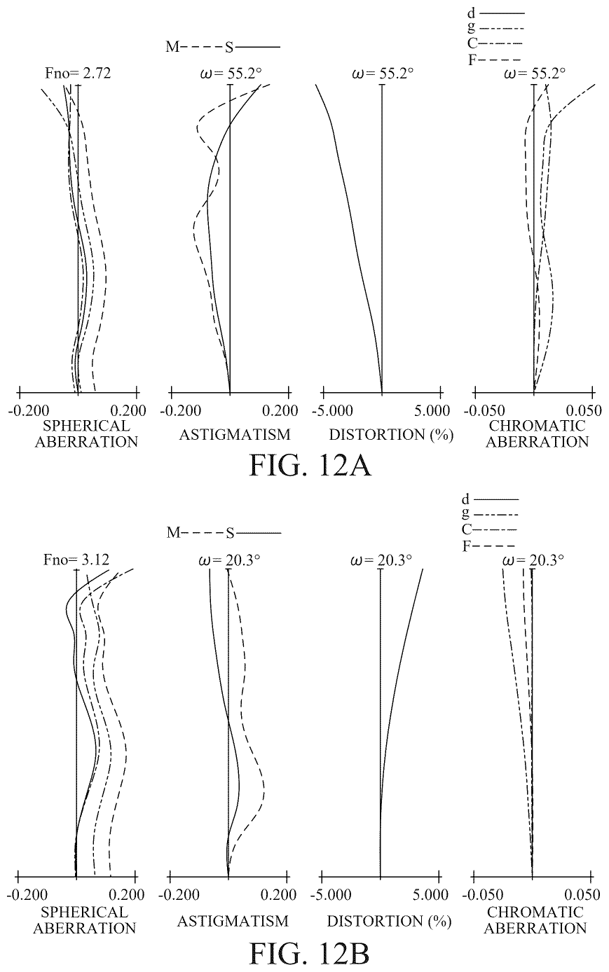

FIG. 12A illustrates longitudinal aberration (spherical aberration, astigmatism, distortion, and chromatic aberration) of the zoom lens according to numerical example 6 in an in-focus state at infinity at a wide-angle end. FIG. 12B illustrates longitudinal aberration of the zoom lens according to numerical example 6 in the in-focus state at infinity at a telephoto end.

### Example 7

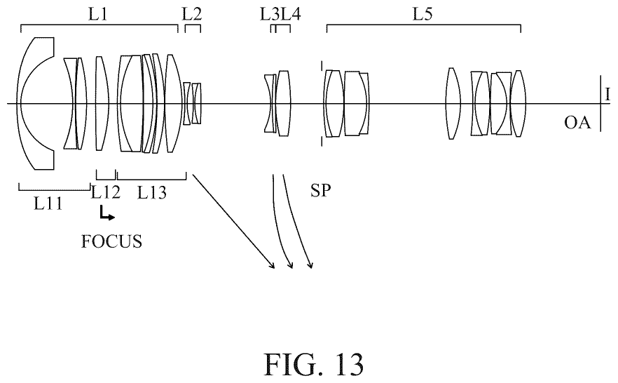

A zoom lens according to Example 7 (numerical example 7) illustrated in FIG. 13 includes, in this order from the object side to the image side, a first lens unit L1 with positive refractive power, a second lens unit L2 with negative refractive power, a third lens unit L3 with negative refractive power, a fourth lens unit L4 with positive refractive power, an aperture stop SP, and a fifth lens unit L5 with positive refractive power. The first lens unit L1 does not move for zooming. The second lens unit L2, the third lens unit L3, and the fourth lens unit L4 constitute the three or more movable lens units that move for zooming. The fifth lens unit L5 is the final lens unit (N-th lens unit) for imaging and does not move for zooming.

The first lens unit L1 includes, in this order from the object side to the image side, a first sub-lens unit L11 with negative refractive power, a second sub-lens unit L12 with positive refractive power, and a third sub-lens unit L13 with positive refractive power. The second sub-lens unit L12 is a focus sub-lens unit that moves toward the image side during focusing from infinity to a close distance.

The second lens unit L2 is a variator unit (V lens unit) that moves toward the image side during zooming from the wide-angle end to the telephoto end. The third lens unit ((N−2)-th lens unit) L3 and the fourth lens unit ((N−1)-th lens unit) L4 move toward the image side during zooming from the wide-angle end to the telephoto end. An optical unit such as an extender lens for focal length conversion may be inserted into the widest air space in the fifth lens unit L5.

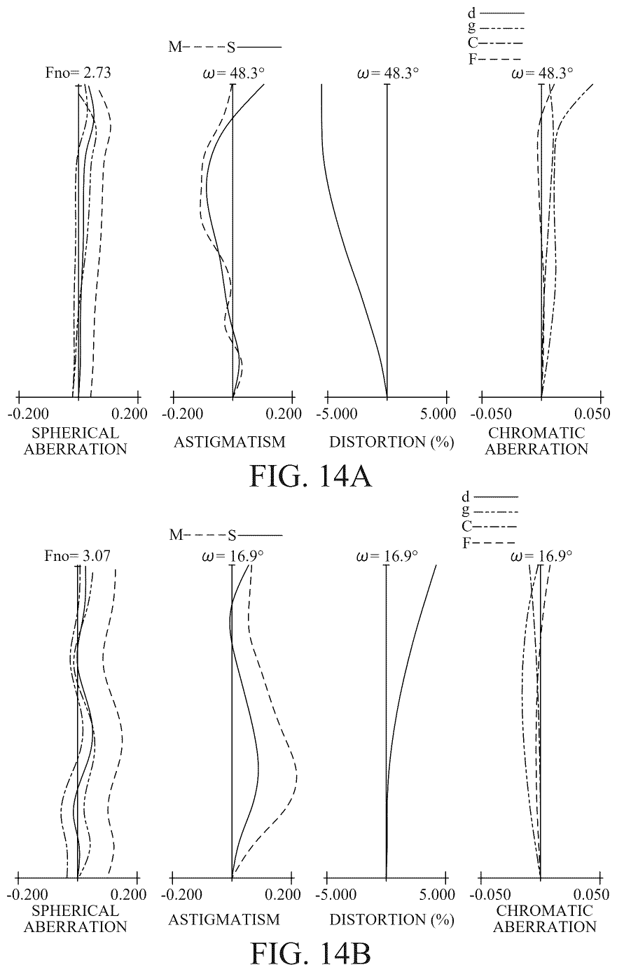

FIG. 14A illustrates longitudinal aberrations (spherical aberration, astigmatism, distortion, and chromatic aberrations) of the zoom lens according to numerical example 7 in the in-focus state at infinity at the wide-angle end. FIG. 14B illustrates longitudinal aberrations of the zoom lens according to numerical example 7 in the in-focus state at infinity at the telephoto end.

Numerical examples 1 to 7 will be illustrated below. In each numerical example, surface number i represents the order of the surface from the object side, r represents a radius of curvature (mm) of an i-th surface, and d represents a distance (mm) on the optical axis between i-th and (i+1)-th surfaces. (variable) of the distance d indicates a distance that changes during zooming, and a distance according to the focal length is illustrated in a separate table. nd represents an absolute refractive index at 1 atmospheric pressure for the d-line of an optical material between i-th and (i+1)-th surfaces. νd is an Abbe number of an optical material between i-th and (i+1)-th surfaces based on the d-line. The Abbe number νd based on the d-line is expressed as:

$$vd = ( Nd - 1 ) / ( NF - NC )$$

where Nd, NF, and NC are refractive indices for the d-line, F-line, and C-line, respectively.

θgF is a partial dispersion ratio of an optical material between i-th and (i+1)-th surfaces to the g-line and F-line.

The partial dispersion ratio of the g-line and F-line is expressed as:

$$θ gF = ( Ng - NF ) / ( NF - NC )$$

where Ng is a refractive index for the g-line.

Each numerical example also illustrates a half angle of view) (° of the zoom lens, in addition to the focal length, F-number, and other specifications of the zoom lens. BF is the back focus, which indicates the air-equivalent distance on the optical axis from the lens surface (last surface) closest to the image plane of the zoom lens to the image surface. The overall lens length is a distance on the optical axis from the lens surface closest to the object (the frontmost surface) of a zoom lens to the final surface plus the back focus. The lens unit data indicates the focal length of each lens unit.

An asterisk “*” next to a surface number means that the surface has an aspheric shape. An aspheric shape is expressed by the following equation:

$$X = \frac{{H}^{2} / R}{1 + \sqrt{1 - ( 1 + k ) {( H / R )}^{2}}} + A 4 \cdot {H}^{4} + A 6 \cdot {H}^{6} + A 8 \cdot {H}^{8} + A 10 \cdot {H}^{10} + A 12 \cdot {H}^{12} + A 14 \cdot {H}^{14} + A 16 \cdot {H}^{16} + A 3 \cdot {H}^{3} + A 5 \cdot {H}^{5} + A 7 \cdot {H}^{7} + A 9 \cdot {H}^{9} + A 11 \cdot {H}^{11} + A 13 \cdot {H}^{13} + A 15 \cdot {H}^{15}$$

where X is a displacement amount from a surface vertex in the optical axis direction, H is a height from the optical axis in a direction orthogonal to the optical axis, a light traveling direction is positive, R is a paraxial radius of curvature, k (K in each numerical example) is a conic constant, and A3 to A16 are aspheric coefficients.

The “e±x” in the conic constant and aspheric coefficients means×10^{±×}. WIDE represents a wide-angle end, MIDDLE represents an intermediate zoom position, and TELE represents a telephoto end.

NUMERICAL EXAMPLE 1
UNIT: mm
SURFACE DATA

| Surface No. | r | d | nd | νd | θgF |
|---|---|---|---|---|---|
| 1* | 42606.960 | 2.15 | 1.89190 | 37.1 | 0.5780 |
| 2 | 27.149 | 13.48 | | | |
| 3* | 58.306 | 1.50 | 1.76385 | 48.5 | 0.5589 |
| 4 | 36.394 | 14.57 | | | |
| 5 | −48.784 | 1.40 | 1.90525 | 35.0 | 0.5848 |
| 6 | −139.348 | 0.20 | | | |
| 7 | 179.434 | 6.60 | 1.89286 | 20.4 | 0.6393 |
| 8 | −95.675 | 3.64 | | | |
| 9 | 1043.755 | 7.00 | 1.59522 | 67.7 | 0.5442 |
| 10* | −68.849 | 4.43 | | | |
| 11 | 1328.657 | 1.70 | 2.00069 | 25.5 | 0.6136 |
| 12 | 58.203 | 12.40 | 1.49700 | 81.5 | 0.5375 |
| 13 | −103.477 | 0.21 | | | |
| 14 | −1068.202 | 14.28 | 1.43875 | 94.7 | 0.5340 |
| 15 | −39.902 | 2.00 | 1.91650 | 31.6 | 0.5911 |
| 16 | −47.581 | 0.20 | | | |
| 17 | 23517.470 | 8.27 | 1.69930 | 51.1 | 0.5552 |
| 18 | −75.192 | (Variable) | | | |
| 19* | −125.330 | 1.20 | 1.69930 | 51.1 | 0.5552 |
| 20 | 35.256 | 3.86 | | | |
| 21 | −220.824 | 0.82 | 1.88300 | 40.8 | 0.5667 |
| 22 | 25.736 | 5.81 | 1.78880 | 28.4 | 0.6009 |
| 23 | −147.111 | (Variable) | | | |
| 24 | −40.955 | 0.85 | 1.53775 | 74.7 | 0.5392 |
| 25 | 45.600 | 2.10 | 1.85478 | 24.8 | 0.6122 |
| 26 | 74.105 | (Variable) | | | |
| 27* | 42.580 | 5.03 | 1.73800 | 32.3 | 0.5900 |
| 28 | 285.359 | (Variable) | | | |
| 29 (SP) | ∞ | 1.00 | | | |
| 30 | 56.171 | 1.30 | 2.05090 | 26.9 | 0.6054 |
| 31 | 38.832 | 6.45 | 1.53172 | 48.8 | 0.5631 |
| 32 | −318.824 | 0.42 | | | |
| 33 | 71.419 | 12.00 | 1.48749 | 70.2 | 0.5300 |
| 34 | −36.119 | 1.30 | 2.00100 | 29.1 | 0.5997 |
| 35 | −113.167 | 41.07 | | | |
| 36 | 59.085 | 7.09 | 1.43875 | 94.7 | 0.5340 |
| 37 | −57.872 | 6.06 | | | |
| 38 | −83.704 | 1.20 | 2.00100 | 29.1 | 0.5997 |
| 39 | 37.639 | 7.27 | 1.89286 | 20.4 | 0.6393 |
| 40 | −75.902 | 0.30 | | | |
| 41 | 48.469 | 9.55 | 1.43875 | 94.7 | 0.5340 |
| 42 | −28.911 | 1.71 | 2.00100 | 29.1 | 0.5997 |
| 43 | 74.397 | 0.20 | | | |
| 44 | 38.078 | 7.37 | 1.48749 | 70.2 | 0.5300 |
| 45 | −77.399 | (Variable) | | | |
| Image Plane | ∞ | | | | |

ASPHERIC DATA

1st Surface
K = 0.00000e+00 A 4 = 1.84806e−05 A 6 = 1.22511e−07 A 8 = 1.72935e−09
A10 = 5.44089e−12 A12 = 3.71223e−15 A14 = 1.19089e−19 A16 = −3.17244e−23
A 3 = −5.50989e−05 A 5 = −1.04907e−06 A 7 = −1.74321e−08 A 9 = −1.16501e−10
A11 = −1.75300e−13 A13 = −4.44063e−17 A15 = 3.53356e−21
3rd Surface
K = 0.00000e+00 A 4 = −1.16790e−05 A 6 = −2.08251e−07 A 8 = −1.47790e−09
A10 = −1.44163e−13 A12 = 4.86545e−15 A14 = 1.20477e−18
A 3 = 4.09795e−05 A 5 = 1.39718e−06 A 7 = 2.21440e−08 A 9 = 5.34933e−11
A11 = −9.07942e−14 A13 = −1.19736e−16
10th Surface
K = 0.00000e+00 A 4 = 1.89977e−06 A 6 = −8.05631e−10 A 8 = −5.52707e−13
A 3 = 3.80032e−06 A 5 = 1.35474e−08 A 7 = 1.53113e−11
19th Surface
K = 0.00000e+00 A 4 = 4.23146e−06 A 6 = −1.89360e−07 A 8 = −2.71304e−09
A10 = −1.38629e−11 A12 = −1.37448e−14
A 3 = 1.88284e−06 A 5 = 4.88427e−07 A 7 = 2.93381e−08 A 9 = 2.00605e−10
A11 = 6.65827e−13
27th Surface
K = 0.00000e+00 A 4 = −2.00990e−06 A 6 = 1.28494e−08 A 8 = 1.11305e−11
A 3 = −1.12208e−06 A 5 = −9.53336e−08 A 7 = −6.19970e−10

VARIOUS DATA
ZOOM RATIO 4.79

| | WIDE | MIDDLE | TELE |
|---|---|---|---|
| Focal Length | 11.48 | 29.42 | 55.01 |
| Fno | 2.72 | 2.73 | 3.66 |
| Half Angle of View (°) | 52.20 | 26.71 | 15.06 |
| Image Height | 14.80 | 14.80 | 14.80 |
| Overall Lens Length | 321.01 | 321.01 | 321.01 |
| BF | 42.48 | 42.48 | 42.48 |
| d18 | 1.09 | 36.15 | 51.18 |
| d23 | 32.77 | 4.24 | 5.29 |
| d26 | 10.43 | 9.60 | 1.11 |
| d28 | 16.22 | 10.52 | 2.95 |
| d45 | 42.48 | 42.48 | 42.48 |

LENS UNIT DATA

| Lens Unit | Starting Surface | Focal Length |
|---|---|---|
| 1 | 1 | 28.85 |
| 2 | 19 | −36.48 |
| 3 | 24 | −56.10 |
| 4 | 27 | 67.22 |
| 5 | 29 | 71.59 |

NUMERICAL EXAMPLE 2
UNIT: mm
SURFACE DATA

| Surface No. | r | d | nd | νd | θgF |
|---|---|---|---|---|---|
| 1* | 99653.968 | 2.10 | 1.83481 | 42.7 | 0.5648 |
| 2 | 26.621 | 13.69 | | | |
| 3* | 53.277 | 1.50 | 1.80400 | 46.5 | 0.5577 |
| 4 | 34.126 | 16.40 | | | |
| 5 | −49.911 | 1.40 | 1.91650 | 31.6 | 0.5911 |
| 6 | −200.550 | 0.22 | | | |
| 7 | 161.315 | 8.93 | 1.80810 | 22.8 | 0.6307 |
| 8 | −83.185 | 1.20 | | | |
| 9 | 5383.525 | 7.60 | 1.59522 | 67.7 | 0.5442 |
| 10* | −71.755 | 3.97 | | | |
| 11 | 274.397 | 12.93 | 1.49700 | 81.5 | 0.5375 |
| 12 | −42.730 | 1.70 | 1.95375 | 32.3 | 0.5905 |
| 13 | −68.081 | 0.20 | | | |
| 14 | 231.453 | 1.70 | 2.00100 | 29.1 | 0.5997 |
| 15 | 50.576 | 14.57 | 1.53775 | 74.7 | 0.5392 |
| 16 | −72.821 | 0.20 | | | |
| 17 | 1767.052 | 6.52 | 1.65412 | 39.7 | 0.5737 |
| 18 | −74.831 | (Variable) | | | |
| 19 | 75.379 | 0.93 | 1.85150 | 40.8 | 0.5695 |
| 20 | 30.722 | 4.03 | | | |
| 21 | −362.321 | 0.85 | 1.76385 | 48.5 | 0.5589 |
| 22 | 20.359 | 6.19 | 1.85478 | 24.8 | 0.6122 |
| 23 | −122.445 | 0.30 | | | |
| 24 | −87.374 | 0.75 | 2.00100 | 29.1 | 0.5997 |
| 25 | 71.254 | (Variable) | | | |
| 26 | 114.085 | 0.70 | 1.83481 | 42.7 | 0.5648 |
| 27 | 21.254 | 4.60 | 1.78880 | 28.4 | 0.6009 |
| 28 | 8996.879 | 1.94 | | | |
| 29 | −34.073 | 0.70 | 1.90525 | 35.0 | 0.5848 |
| 30 | −357.713 | (Variable) | | | |
| 31 (SP) | ∞ | 4.93 | | | |
| 32* | 143.199 | 3.59 | 1.51633 | 64.1 | 0.5353 |
| 33 | −304.460 | 0.15 | | | |
| 34 | 48.907 | 1.10 | 1.89190 | 37.1 | 0.5780 |
| 35 | 37.693 | 5.95 | 1.68893 | 31.1 | 0.6004 |
| 36 | −2292.893 | (Variable) | | | |
| 37 | 85.702 | 0.98 | 1.96300 | 24.1 | 0.6212 |
| 38 | 29.559 | 8.25 | 1.60311 | 60.6 | 0.5415 |
| 39 | −104.561 | 41.06 | | | |
| 40 | 79.543 | 7.29 | 1.53775 | 74.7 | 0.5392 |
| 41 | −53.892 | 5.76 | | | |
| 42 | −78.542 | 1.00 | 2.00100 | 29.1 | 0.5997 |
| 43 | 45.550 | 7.00 | 1.94594 | 18.0 | 0.6546 |
| 44 | −76.212 | 0.20 | | | |
| 45 | 45.621 | 8.72 | 1.49700 | 81.5 | 0.5375 |
| 46 | −37.219 | 1.00 | 2.05090 | 26.9 | 0.6054 |
| 47 | 41.356 | 0.20 | | | |
| 48 | 29.384 | 12.43 | 1.53172 | 48.8 | 0.5631 |
| 49 | −27.158 | 1.00 | 2.00100 | 29.1 | 0.5997 |
| 50 | −58.022 | (Variable) | | | |
| Image Plane | ∞ | | | | |

ASPHERIC DATA

1st Surface
K = 0.00000e+00 A 4 = −2.49940e−06 A 6 = −4.30470e−07 A 8 = −1.39799e−09
A10 = −2.33619e−13 A12 = 2.12400e−16 A14 = −1.50597e−19 A16 = −1.63120e−23
A 3 = 2.26644e−05 A 5 = 3.11265e−06 A 7 = 3.18235e−08 A 9 = 3.38626e−11
A11 = −9.41805e−15 A13 = 2.02128e−18 A15 = 2.56180e−21
3rd Surface
K = 0.00000e+00 A 4 = 7.41666e−06 A 6 = 8.87271e−07 A 8 = 9.94141e−09
A10 = −6.05462e−12 A12 = −6.58359e−14 A14 = 8.34199e−17 A16 = 2.60180e−20
A 3 = −1.78927e−05 A 5 = −4.22301e−06 A 7 = −1.18514e−07 A 9 = −4.12571e−10
A11 = 1.59628e−12 A13 = −1.09031e−17 A15 = −2.57650e−18
10th Surface
K = 5.23767e−02 A 4 = 1.01819e−06 A 6 = −2.33763e−08 A 8 = −5.13972e−11
A10 = 3.03774e−13 A12 = 7.15857e−17 A14 = 9.05692e−20 A16 = 2.78191e−23
A 3 = 2.71548e−07 A 5 = 1.38358e−07 A 7 = 1.90027e−09 A 9 = −3.22019e−12
A11 = −8.94836e−15 A13 = −9.65298e−20 A15 = −3.02326e−21
32nd Surface
K = 1.17920e+01 A 4 = −4.24919e−06 A 6 = −1.44582e−08 A 8 = −1.89904e−11
A 3 = 4.86489e−07 A 5 = 1.22033e−07 A 7 = 8.46187e−10

VARIOUS DATA
ZOOM RATIO 4.75

| | WIDE | MIDDLE | TELE |
|---|---|---|---|
| Focal Length | 11.57 | 28.77 | 55.00 |
| Fno | 2.73 | 2.73 | 3.56 |
| Half Angle of View (°) | 51.98 | 27.22 | 15.06 |
| Image Height | 14.80 | 14.80 | 14.80 |
| Overall Lens Length | 313.08 | 313.08 | 313.08 |
| BF | 38.32 | 38.32 | 38.32 |
| d18 | 1.00 | 29.97 | 42.38 |
| d25 | 23.21 | 3.62 | 2.74 |
| d30 | 12.43 | 10.93 | 1.90 |
| d36 | 11.67 | 3.80 | 1.30 |
| d50 | 38.32 | 38.32 | 38.32 |

LENS UNIT DATA

| Lens Unit | Starting Surface | Focal Length |
|---|---|---|
| 1 | 1 | 27.21 |
| 2 | 19 | −28.97 |
| 3 | 26 | −54.58 |
| 4 | 31 | 54.45 |
| 5 | 37 | 80.65 |

NUMERICAL EXAMPLE 3
UNIT: mm
SURFACE DATA

| Surface No. | r | d | nd | νd | θgF |
|---|---|---|---|---|---|
| 1* | 94.027 | 2.40 | 1.76385 | 48.5 | 0.5589 |
| 2 | 27.780 | 21.32 | | | |
| 3 | 517.012 | 1.60 | 2.00100 | 29.1 | 0.5997 |
| 4 | 36.378 | 16.17 | | | |
| 5 | −34.012 | 1.50 | 1.88300 | 40.8 | 0.5667 |
| 6 | −43.489 | 1.32 | | | |
| 7 | 221.920 | 6.61 | 1.89286 | 20.4 | 0.6393 |
| 8 | −129.479 | 9.15 | | | |
| 9 | 98.501 | 10.65 | 1.61800 | 63.3 | 0.5441 |
| 10* | −70.521 | 8.43 | | | |
| 11 | −101.895 | 3.54 | 1.49700 | 81.5 | 0.5375 |
| 12 | −71.110 | 0.20 | | | |
| 13 | −68.201 | 1.80 | 1.76385 | 48.5 | 0.5589 |
| 14 | −60.984 | 0.20 | | | |
| 15 | −68.309 | 1.65 | 1.95375 | 32.3 | 0.5905 |
| 16 | 63.565 | 10.11 | 1.43875 | 94.9 | 0.5340 |
| 17 | −52.618 | 0.20 | | | |
| 18 | 159.070 | 6.14 | 1.76385 | 48.5 | 0.5589 |
| 19 | −78.200 | (Variable) | | | |
| 20* | −858.899 | 1.20 | 1.90525 | 35.0 | 0.5848 |
| 21 | 45.413 | 3.85 | | | |
| 22 | −127.124 | 0.80 | 1.59522 | 67.7 | 0.5442 |
| 23 | 74.274 | 3.85 | 1.85478 | 24.8 | 0.6122 |
| 24 | −75.499 | 1.01 | | | |
| 25 | −44.591 | 0.80 | 1.76385 | 48.5 | 0.5589 |
| 26 | −117.809 | (Variable) | | | |
| 27 | −63.485 | 0.80 | 1.60300 | 65.4 | 0.5401 |
| 28 | 46.687 | 2.21 | 1.85478 | 24.8 | 0.6122 |
| 29 | 94.896 | (Variable) | | | |
| 30 (SP) | ∞ | 4.11 | | | |
| 31* | 28.292 | 6.16 | 1.58144 | 40.8 | 0.5774 |
| 32 | 588.133 | 0.20 | | | |
| 33 | 67.616 | 1.00 | 1.76182 | 26.5 | 0.6136 |
| 34 | 37.713 | (Variable) | | | |
| 35 | 653.952 | 2.82 | 1.56732 | 42.8 | 0.5731 |
| 36 | −105.975 | 0.20 | | | |
| 37 | 67.927 | 1.00 | 2.05090 | 26.9 | 0.6054 |
| 38 | 37.095 | 4.74 | 1.53775 | 74.7 | 0.5392 |
| 39 | −4301.074 | 51.46 | | | |
| 40 | 47.017 | 7.51 | 1.55200 | 70.7 | 0.5421 |
| 41 | −101.660 | 0.40 | | | |
| 42 | 43.718 | 6.08 | 1.80810 | 22.8 | 0.6307 |
| 43 | −156.796 | 1.10 | 1.88300 | 40.8 | 0.5667 |
| 44 | 23.131 | 1.30 | | | |
| 45 | 23.063 | 12.76 | 1.43875 | 94.7 | 0.5340 |
| 46 | −25.599 | 1.50 | 2.05090 | 26.9 | 0.6054 |
| 47 | 112.290 | 4.63 | | | |
| 48 | 62.194 | 8.64 | 1.48749 | 70.2 | 0.5300 |
| 49 | −37.676 | (Variable) | | | |
| Image Plane | ∞ | | | | |

ASPHERIC DATA

1st Surface
K = 0.00000e+00 A 4 = 3.45445e−06 A 6 = −1.27211e−09 A 8 = 3.91601e−13
A10 = 1.13301e−15 A12 = −1.39854e−18 A14 = 7.08932e−22 A16 = −1.23412e−25
10th Surface
K = 0.00000e+00 A 4 = 1.15440e−06 A 6 = −3.35230e−10 A 8 = 6.56062e−14
20th Surface
K = 0.00000e+00 A 4 = 1.51152e−06 A 6 = −2.45352e−09 A 8 = 3.01831e−11
A10 = −1.76333e−13 A12 = 3.53546e−16
31st Surface
K = 0.00000e+00 A 4 = −6.88362e−06 A 6 = −1.52829e−09 A 8 = −5.34036e−12

VARIOUS DATA
ZOOM RATIO 3.37

| | WIDE | MIDDLE | TELE |
|---|---|---|---|
| Focal Length | 11.89 | 31.51 | 40.00 |
| Fno | 2.90 | 2.90 | 3.50 |
| Half Angle of View (°) | 51.23 | 25.16 | 20.30 |
| Image Height | 14.80 | 14.80 | 14.80 |
| Overall Lens Length | 329.16 | 329.16 | 329.16 |
| BF | 37.00 | 37.00 | 37.00 |
| d19 | 1.00 | 44.56 | 52.24 |
| d26 | 39.30 | 3.58 | 2.00 |
| d29 | 8.43 | 5.29 | 1.00 |
| d34 | 10.32 | 5.62 | 3.81 |
| d49 | 37.00 | 37.00 | 37.00 |

LENS UNIT DATA

| Lens Unit | Starting Surface | Focal Length |
|---|---|---|
| 1 | 1 | 32.71 |
| 2 | 20 | −46.54 |
| 3 | 27 | −75.91 |
| 4 | 30 | 84.73 |
| 5 | 35 | 73.37 |

NUMERICAL EXAMPLE 4
UNIT: mm
SURFACE DATA

| Surface No. | r | d | nd | νd | θgF |
|---|---|---|---|---|---|
| 1* | 10000.000 | 2.20 | 1.83481 | 42.7 | 0.5648 |
| 2 | 27.261 | 10.90 | | | |
| 3* | 43.746 | 1.55 | 1.85150 | 40.8 | 0.5695 |
| 4 | 29.780 | 16.94 | | | |
| 5 | −54.008 | 1.45 | 1.95375 | 32.3 | 0.5905 |
| 6 | 2340.232 | 0.20 | | | |
| 7 | 126.680 | 7.91 | 1.80810 | 22.8 | 0.6307 |
| 8 | −96.980 | 1.49 | | | |
| 9 | 337.211 | 8.36 | 1.59522 | 67.7 | 0.5442 |
| 10* | −58.106 | 2.89 | | | |
| 11 | 311.073 | 13.21 | 1.43875 | 94.7 | 0.5340 |
| 12 | −37.563 | 1.60 | 1.95375 | 32.3 | 0.5905 |
| 13 | −52.130 | 0.20 | | | |
| 14 | 195.594 | 1.60 | 2.00100 | 29.1 | 0.5997 |
| 15 | 53.751 | 14.24 | 1.43875 | 94.7 | 0.5340 |
| 16 | −56.590 | 0.20 | | | |
| 17 | −307.119 | 4.72 | 1.76634 | 35.8 | 0.5792 |
| 18 | −68.430 | (Variable) | | | |
| 19 | 67.923 | 0.95 | 1.80400 | 46.5 | 0.5577 |
| 20 | 32.553 | 2.99 | | | |
| 21 | −4920.510 | 0.85 | 1.76385 | 48.5 | 0.5589 |
| 22 | 22.528 | 5.55 | 1.78880 | 28.4 | 0.6009 |
| 23 | −75.906 | (Variable) | | | |
| 24 | −70.205 | 0.75 | 1.88300 | 40.8 | 0.5667 |
| 25 | 50.820 | (Variable) | | | |
| 26 | −32.470 | 0.70 | 1.80400 | 46.5 | 0.5577 |
| 27 | 29.951 | 2.65 | 1.78880 | 28.4 | 0.6009 |
| 28 | 433.737 | (Variable) | | | |
| 29 (SP) | ∞ | 2.04 | | | |
| 30 | −8622.845 | 1.00 | 1.83481 | 42.7 | 0.5648 |
| 31 | 54.401 | 3.85 | 1.67300 | 38.3 | 0.5757 |
| 32 | −599.694 | 0.20 | | | |
| 33* | 36.239 | 7.96 | 1.57501 | 41.5 | 0.5767 |
| 34 | −138.526 | (Variable) | | | |
| 35 | 263.730 | 2.31 | 1.48749 | 70.2 | 0.5300 |
| 36 | −187.158 | 0.20 | | | |
| 37 | 72.439 | 1.20 | 2.00069 | 25.5 | 0.6136 |
| 38 | 32.243 | 8.37 | 1.51823 | 58.9 | 0.5457 |
| 39 | −113.669 | 41.34 | | | |
| 40 | 74.294 | 7.17 | 1.49700 | 81.5 | 0.5375 |
| 41 | −55.213 | 0.72 | | | |
| 42 | −216.396 | 1.20 | 2.00100 | 29.1 | 0.5997 |
| 43 | 25.638 | 9.15 | 1.89286 | 20.4 | 0.6393 |
| 44 | −2098.664 | 0.20 | | | |
| 45 | 29.296 | 8.30 | 1.67300 | 38.3 | 0.5757 |
| 46 | −108.576 | 1.58 | 2.00100 | 29.1 | 0.5997 |
| 47 | 24.135 | 0.20 | | | |
| 48 | 21.983 | 14.17 | 1.43875 | 94.7 | 0.5340 |
| 49 | −24.253 | 1.00 | 2.00100 | 29.1 | 0.5997 |
| 50 | −52.485 | (Variable) | | | |
| Image Plane | ∞ | | | | |

ASPHERIC DATA

1st Surface
K = 0.00000e+00 A 4 = −4.39106e−05 A 6 = −1.26499e−06 A 8 = −3.62054e−09
A10 = −6.42274e−13 A12 = 3.92028e−16 A14 = 6.61559e−20 A16 = 7.34553e−24
A 3 = 1.49036e−04 A 5 = 1.08520e−05 A 7 = 8.69501e−08 A 9 = 8.38675e−11
A11 = −1.50177e−14 A13 = −3.97045e−18 A15 = −1.20551e−21
3rd Surface
K = 0.00000e+00 A 4 = 2.70307e−05 A 6 = 9.13168e−07 A 8 = 9.74093e−09
A10 = 2.53181e−11 A12 = −1.22397e−14 A14 = 7.66186e−17 A16 = 2.34551e−20
A 3 = −9.70765e−05 A 5 = −6.69142e−06 A 7 = −1.01727e−07 A 9 = −6.68975e−10
A11 = −1.89298e−13 A13 = −6.65266e−16 A15 = −2.28044e−18
10th Surface
K = 0.00000e+00 A 4 = 3.66220e−06 A 6 = 4.66240e−09 A 8 = 4.98196e−13
A 3 = −5.18478e−06 A 5 = −9.23355e−08 A 7 = −9.72622e−11
33rd Surface
K = 0.00000e+00 A 4 = −7.27259e−06 A 6 = 2.24551e−09 A 8 = −2.15475e−12

VARIOUS DATA
ZOOM RATIO 4.81

| | WIDE | MIDDLE | TELE |
|---|---|---|---|
| Focal Length | 11.44 | 28.81 | 55.02 |
| Fno | 2.73 | 2.73 | 3.66 |
| Half Angle of View (°) | 52.30 | 27.19 | 15.06 |
| Image Height | 14.80 | 14.80 | 14.80 |
| Overall Lens Length | 307.39 | 307.39 | 307.39 |
| BF | 39.12 | 39.12 | 39.12 |
| d18 | 0.98 | 27.50 | 38.86 |
| d23 | 1.00 | 2.87 | 4.26 |
| d25 | 23.60 | 4.18 | 4.43 |
| d28 | 11.96 | 10.23 | 2.97 |
| d34 | 14.47 | 7.22 | 1.48 |
| d50 | 39.12 | 39.12 | 39.12 |

LENS UNIT DATA

| Lens Unit | Starting Surface | Focal Length |
|---|---|---|
| 1 | 1 | 26.71 |
| 2 | 19 | −1804.98 |
| 3 | 24 | −33.29 |
| 4 | 26 | −36.79 |
| 5 | 29 | 55.77 |
| 6 | 35 | 70.65 |

NUMERICAL EXAMPLE 5
UNIT: mm
SURFACE DATA

| Surface No. | r | d | nd | νd | θgF |
|---|---|---|---|---|---|
| 1* | ∞ | 2.10 | 1.83481 | 42.7 | 0.5648 |
| 2 | 25.809 | 14.59 | | | |
| 3* | 84.172 | 1.50 | 1.80400 | 46.5 | 0.5577 |
| 4 | 40.603 | 13.67 | | | |
| 5 | −44.135 | 1.40 | 1.89190 | 37.1 | 0.5780 |
| 6 | −112.235 | 0.11 | | | |
| 7 | 188.051 | 7.90 | 1.80810 | 22.8 | 0.6307 |
| 8 | −76.990 | 1.45 | | | |
| 9 | −237.991 | 7.64 | 1.49700 | 81.5 | 0.5375 |
| 10* | −49.723 | 4.09 | | | |
| 11 | −946.175 | 10.96 | 1.48749 | 70.2 | 0.5300 |
| 12 | −40.594 | 1.75 | 2.00100 | 29.1 | 0.5997 |
| 13 | −65.641 | 0.21 | | | |
| 14 | 282.349 | 1.70 | 2.00100 | 29.1 | 0.5997 |
| 15 | 65.774 | 15.54 | 1.43875 | 94.7 | 0.5340 |
| 16 | −56.568 | 0.19 | | | |
| 17 | 1916.533 | 7.65 | 1.76385 | 48.5 | 0.5589 |
| 18 | −74.742 | (Variable) | | | |
| 19* | 205.779 | 1.20 | 1.83481 | 42.7 | 0.5648 |
| 20 | 27.352 | 4.21 | | | |
| 21 | −167.761 | 0.82 | 1.83481 | 42.7 | 0.5648 |
| 22 | 22.203 | 6.79 | 1.78880 | 28.4 | 0.6009 |
| 23 | −63.011 | (Variable) | | | |
| 24 | −32.050 | 0.82 | 1.88300 | 40.8 | 0.5667 |
| 25 | −84.151 | (Variable) | | | |
| 26 | −39.149 | 0.85 | 1.59522 | 67.7 | 0.5442 |
| 27 | 62.164 | 2.31 | 1.85478 | 24.8 | 0.6122 |
| 28 | 157.587 | (Variable) | | | |
| 29* | 52.222 | 4.12 | 1.85150 | 40.8 | 0.5695 |
| 30 | −199.701 | (Variable) | | | |
| 31 (SP) | ∞ | 1.80 | | | |
| 32 | 39.995 | 6.88 | 1.51742 | 52.4 | 0.5564 |
| 33 | −146.845 | 0.23 | | | |
| 34 | 279.585 | 1.00 | 2.00100 | 29.1 | 0.5997 |
| 35 | 33.798 | 6.40 | 1.51633 | 64.1 | 0.5353 |
| 36 | −160.634 | 0.43 | | | |
| 37 | −368.954 | 5.64 | 1.67270 | 32.1 | 0.5988 |
| 38 | −30.284 | 1.00 | 2.00100 | 29.1 | 0.5997 |
| 39 | −80.389 | 41.40 | | | |
| 40 | 93.888 | 5.18 | 1.43875 | 94.7 | 0.5340 |
| 41 | −60.517 | 0.70 | | | |
| 42 | 57.562 | 7.87 | 1.80809 | 22.7 | 0.6306 |
| 43 | −35.852 | 1.10 | 1.89190 | 37.1 | 0.5780 |
| 44 | 34.242 | 0.82 | | | |
| 45 | 31.872 | 13.49 | 1.43875 | 94.7 | 0.5340 |
| 46 | −23.478 | 1.10 | 2.00100 | 29.1 | 0.5997 |
| 47 | 171.178 | 0.13 | | | |
| 48 | 52.667 | 8.91 | 1.48749 | 70.2 | 0.5300 |
| 49 | −35.296 | (Variable) | | | |
| Image Plane | ∞ | | | | |

ASPHERIC DATA

1st Surface
K = 0.00000e+00 A 4 = 2.01487e−05 A 6 = 2.48992e−08 A 8 = 2.17115e−11
A10 = −1.96498e−13 A12 = −1.74230e−16 A14 = −3.30200e−19 A16 = −4.27190e−23
A 3 = −4.92267e−05 A 5 = −8.40544e−07 A 7 = −9.83600e−10 A 9 = 2.28192e−12
A11 = 6.34512e−15 A13 = 8.73990e−18 A15 = 6.07222e−21
3rd Surface
K = 0.00000e+00 A 4 = −1.79865e−05 A 6 = 1.08737e−07 A 8 = 2.67194e−09
A10 = −2.65927e−10 A12 = −1.84184e−12 A14 = −1.97641e−15 A16 = −1.90543e−19
A 3 = 4.04572e−05 A 5 = 1.49144e−06 A 7 = −5.30553e−08 A 9 = 1.16096e−09
A11 = 2.84179e−11 A13 = 7.62209e−14 A15 = 2.93416e−17
10th Surface
K = 0.00000e+00 A 4 = −2.18415e−06 A 6 = −2.03336e−07 A 8 = −1.52986e−09
A10 = 5.10495e−12 A12 = 2.25271e−14 A14 = 9.63941e−19 A16 = −1.87371e−21
A 3 = 9.29120e−06 A 5 = 1.14812e−06 A 7 = 2.31796e−08 A 9 = 2.52009e−11
A11 = −5.09518e−13 A13 = −4.71919e−16 A15 = 1.41597e−19
19th Surface
K = 0.00000e+00 A 4 = 5.62296e−06 A 6 = 9.66460e−07 A 8 = 6.14358e−08
A10 = −8.91142e−10 A12 = −2.54378e−11 A14 = −7.20136e−14 A16 = −1.75328e−17
A 3 = −3.52425e−07 A 5 = −1.20759e−06 A 7 = −3.48990e−07 A 9 = −3.12076e−09
A11 = 2.23374e−10 A13 = 1.72991e−12 A15 = 1.70114e−15
29th Surface
K = 0.00000e+00 A 4 = −8.28442e−06 A 6 = −4.71556e−07 A 8 = −5.90301e−09
A10 = 3.62432e−12 A12 = 6.58822e−14 A14 = 8.73138e−17 A16 = −5.58289e−21
A 3 = 3.07013e−06 A 5 = 1.82756e−06 A 7 = 7.02954e−08 A 9 = 2.30046e−10
A11 = −9.68540e−13 A13 = −3.02124e−15 A15 = −9.83633e−19

VARIOUS DATA
ZOOM RATIO 5.45

| | WIDE | MIDDLE | TELE |
|---|---|---|---|
| Focal Length | 10.99 | 29.91 | 59.97 |
| Fno | 2.99 | 3.00 | 4.00 |
| Half Angle of View (°) | 53.39 | 26.33 | 13.86 |
| Image Height | 14.80 | 14.80 | 14.80 |
| Overall Lens Length | 320.99 | 320.99 | 320.99 |
| BF | 43.15 | 43.15 | 43.15 |
| d18 | 1.26 | 36.15 | 51.10 |
| d23 | 5.70 | 1.47 | 3.38 |
| d25 | 28.22 | 4.92 | 3.83 |
| d28 | 3.82 | 6.42 | 0.35 |
| d30 | 21.20 | 11.23 | 1.52 |
| d49 | 43.15 | 43.15 | 43.15 |

LENS UNIT DATA

| Lens Unit | Starting Surface | Focal Length |
|---|---|---|
| 1 | 1 | 27.60 |
| 2 | 19 | −53.93 |
| 3 | 24 | −59.06 |
| 4 | 26 | −60.47 |
| 5 | 29 | 48.98 |
| 6 | 31 | 74.85 |

NUMERICAL EXAMPLE 6
UNIT: mm
SURFACE DATA

| Surface No. | r | d | nd | νd | θgF |
|---|---|---|---|---|---|
| 1* | 99721.237 | 2.10 | 1.88300 | 40.8 | 0.5667 |
| 2 | 25.124 | 15.63 | | | |
| 3* | 68.600 | 1.50 | 1.81600 | 46.6 | 0.5568 |
| 4 | 33.546 | 14.38 | | | |
| 5 | −45.317 | 1.40 | 1.89190 | 37.1 | 0.5780 |
| 6 | −178.717 | 0.11 | | | |
| 7 | 147.960 | 9.19 | 1.80810 | 22.8 | 0.6307 |
| 8 | −69.637 | 3.61 | | | |
| 9 | −409.774 | 8.82 | 1.49700 | 81.5 | 0.5375 |
| 10* | −47.650 | 4.23 | | | |
| 11 | −210.917 | 8.86 | 1.49700 | 81.5 | 0.5375 |
| 12 | −39.439 | 1.75 | 2.00100 | 29.1 | 0.5997 |
| 13 | −77.835 | 0.21 | | | |
| 14 | 325.247 | 1.70 | 2.00100 | 29.1 | 0.5997 |
| 15 | 63.632 | 12.38 | 1.49700 | 81.5 | 0.5375 |
| 16 | −88.789 | 0.19 | | | |
| 17 | ∞ | 8.47 | 1.76385 | 48.5 | 0.5589 |
| 18 | −64.157 | (Variable) | | | |
| 19 | −402.768 | 4.00 | 1.54814 | 45.8 | 0.5686 |
| 20 | −125.167 | (Variable) | | | |
| 21* | 203.099 | 1.20 | 1.76385 | 48.5 | 0.5589 |
| 22 | 32.045 | 3.78 | | | |
| 23 | −462.841 | 0.82 | 1.88300 | 40.8 | 0.5667 |
| 24 | 21.939 | 7.59 | 1.78880 | 28.4 | 0.6009 |
| 25 | −111.087 | 1.86 | | | |
| 26 | −33.589 | 0.82 | 1.80400 | 46.5 | 0.5577 |
| 27 | −62.504 | (Variable) | | | |
| 28 | −39.248 | 0.85 | 1.59522 | 67.7 | 0.5442 |
| 29 | 67.288 | 2.27 | 1.85478 | 24.8 | 0.6122 |
| 30 | 134.040 | (Variable) | | | |
| 31* | 50.024 | 4.32 | 1.90525 | 35.0 | 0.5848 |
| 32 | −1067.543 | (Variable) | | | |
| 33 (SP) | ∞ | 1.83 | | | |
| 34 | 48.986 | 7.26 | 1.51633 | 64.1 | 0.5353 |
| 35 | −95.477 | 0.23 | | | |
| 36 | 300.241 | 1.00 | 2.00100 | 29.1 | 0.5997 |
| 37 | 35.947 | 4.01 | 1.48749 | 70.2 | 0.5300 |
| 38 | 133.716 | 0.93 | | | |
| 39 | 138.480 | 7.51 | 1.67270 | 32.1 | 0.5988 |
| 40 | −29.019 | 1.00 | 2.00100 | 29.1 | 0.5997 |
| 41 | −75.084 | 34.89 | | | |
| 42 | 90.109 | 8.59 | 1.43875 | 94.7 | 0.5340 |
| 43 | −53.209 | 1.19 | | | |
| 44 | 53.058 | 6.86 | 1.80810 | 22.8 | 0.6307 |
| 45 | −50.597 | 1.10 | 1.95375 | 32.3 | 0.5905 |
| 46 | 31.506 | 0.92 | | | |
| 47 | 30.981 | 16.09 | 1.43875 | 94.7 | 0.5340 |
| 48 | −21.647 | 1.10 | 1.90525 | 35.0 | 0.5848 |
| 49 | 303.670 | 0.16 | | | |
| 50 | 71.622 | 9.78 | 1.48749 | 70.2 | 0.5300 |
| 51 | −31.057 | (Variable) | | | |
| Image Plane | ∞ | | | | |

ASPHERIC DATA

1st Surface
K = 0.00000e+00 A 4 = 2.00578e−05 A 6 = −3.49834e−08 A 8 = −1.97814e−10
A10 = −3.18166e−13 A12 = −2.34430e−16 A14 = −3.94878e−19 A16 = −4.94966e−23
A 3 = −2.69692e−05 A 5 = −4.49193e−07 A 7 = 3.63294e−09 A 9 = 8.84344e−12
A11 = 8.19638e−15 A13 = 1.11763e−17 A15 = 7.06579e−21
3rd Surface
K = 0.00000e+00 A 4 = −1.88837e−05 A 6 = 1.14408e−08 A 8 = 1.30608e−09
A10 = −2.67806e−10 A12 = −1.84918e−12 A14 = −1.97831e−15 A16 = −1.87551e−19
A 3 = 2.30237e−05 A 5 = 1.83049e−06 A 7 = −3.77502e−08 A 9 = 1.22832e−09
A11 = 2.85063e−11 A13 = 7.65091e−14 A15 = 2.91882e−17
10th Surface
K = 0.00000e+00 A 4 = −9.99055e−07 A 6 = −1.14112e−07 A 8 = −8.45719e−10
A10 = 4.38289e−12 A12 = 2.18286e−14 A14 = 2.74189e−18 A16 = −2.08352e−21
A 3 = 4.92584e−06 A 5 = 6.85638e−07 A 7 = 1.27647e−08 A 9 = 8.15011e−12
A11 = −4.50105e−13 A13 = −5.24524e−16 A15 = 1.33374e−19
21st Surface
K = 0.00000e+00 A 4 = 5.11270e−06 A 6 = 1.27488e−06 A 8 = 6.91406e−08
A10 = −9.64538e−10 A12 = −2.50957e−11 A14 = −6.51372e−14 A16 = −1.40914e−17
A 3 = −7.60726e−07 A 5 = −1.89147e−06 A 7 = −4.19029e−07 A 9 = −3.20858e−09
A11 = 2.29422e−10 A13 = 1.63798e−12 A15 = 1.45855e−15
31st Surface
K = 0.00000e+00 A 4 = −7.29704e−06 A 6 = −3.62499e−07 A 8 = −3.90225e−09
A10 = 2.84575e−11 A12 = 1.00025e−13 A14 = 4.24406e−17 A16 = 2.35975e−20
A 3 = 3.87591e−06 A 5 = 1.44823e−06 A 7 = 5.36549e−08 A 9 = −1.70348e−11
A11 = −2.45064e−12 A13 = −2.20859e−15 A15 = −1.34738e−18

VARIOUS DATA
ZOOM RATIO 3.88

| | WIDE | MIDDLE | TELE |
|---|---|---|---|
| Focal Length | 10.30 | 24.06 | 39.99 |
| Fno | 2.72 | 2.73 | 3.12 |
| Half Angle of View (°) | 55.16 | 31.60 | 20.31 |
| Image Height | 14.80 | 14.80 | 14.80 |
| Overall Lens Length | 321.00 | 321.00 | 321.00 |
| BF | 43.19 | 43.19 | 43.19 |
| d18 | 0.19 | 2.23 | 3.00 |
| d20 | 0.99 | 29.75 | 42.18 |
| d27 | 27.90 | 4.02 | 3.54 |
| d30 | 4.94 | 5.49 | 0.37 |
| d32 | 17.30 | 9.83 | 2.23 |
| d51 | 43.19 | 43.19 | 43.19 |

LENS UNIT DATA

| Lens Unit | Starting Surface | Focal Length |
|---|---|---|
| 1 | 1 | 32.36 |
| 2 | 19 | 329.63 |
| 3 | 21 | −31.69 |
| 4 | 28 | −56.20 |
| 5 | 31 | 52.88 |
| 6 | 33 | 72.84 |

NUMERICAL EXAMPLE 7
UNIT: mm
SURFACE DATA

| Surface No. | r | d | nd | νd | θgF |
|---|---|---|---|---|---|
| 1* | 107.128 | 2.15 | 1.88300 | 40.8 | 0.5667 |
| 2 | 26.580 | 27.77 | | | |
| 3* | −59.702 | 1.40 | 2.00100 | 29.1 | 0.5997 |
| 4 | 349.036 | 0.20 | | | |
| 5 | 208.619 | 5.83 | 1.89286 | 20.4 | 0.6393 |
| 6 | −99.748 | 4.85 | | | |
| 7 | 725.707 | 7.00 | 1.59522 | 67.7 | 0.5442 |
| 8* | −71.098 | 4.61 | | | |
| 9 | 159.628 | 1.70 | 2.00100 | 29.1 | 0.5997 |
| 10 | 54.415 | 12.10 | 1.49700 | 81.5 | 0.5375 |
| 11 | −225.042 | 0.21 | | | |
| 12 | −491.474 | 5.03 | 1.43875 | 94.7 | 0.5340 |
| 13 | −73.242 | 2.00 | 1.84666 | 23.8 | 0.6205 |
| 14 | −89.709 | 0.20 | | | |
| 15 | −147.905 | 4.00 | 1.83481 | 42.7 | 0.5648 |
| 16 | −91.410 | 0.20 | | | |
| 17 | 206.052 | 9.18 | 1.51823 | 58.9 | 0.5457 |
| 18 | −65.422 | (Variable) | | | |
| 19* | −77.250 | 1.20 | 1.89190 | 37.1 | 0.5780 |
| 20 | 35.027 | 3.32 | | | |
| 21 | −77.045 | 0.82 | 1.88300 | 40.8 | 0.5667 |
| 22 | 33.725 | 3.26 | 1.89286 | 20.4 | 0.6393 |
| 23 | −226.080 | (Variable) | | | |
| 24 | −31.283 | 0.85 | 1.49700 | 81.5 | 0.5375 |
| 25 | 139.894 | 1.81 | 1.85478 | 24.8 | 0.6122 |
| 26 | 828.336 | (Variable) | | | |
| 27* | 62.698 | 8.00 | 1.88300 | 40.8 | 0.5667 |
| 28 | −105.639 | (Variable) | | | |
| 29 (SP) | ∞ | 1.00 | | | |
| 30 | 109.543 | 1.30 | 1.90525 | 35.0 | 0.5848 |
| 31 | 47.934 | 9.55 | 1.59522 | 67.7 | 0.5442 |
| 32 | −61.090 | 0.18 | | | |
| 33 | 261.961 | 12.00 | 1.53775 | 74.7 | 0.5392 |
| 34 | −34.275 | 1.30 | 1.95375 | 32.3 | 0.5905 |
| 35 | −167.219 | 41.07 | | | |
| 36 | 91.628 | 7.88 | 1.43875 | 94.7 | 0.5340 |
| 37 | −46.727 | 6.60 | | | |
| 38 | −145.495 | 1.20 | 2.00100 | 29.1 | 0.5997 |
| 39 | 38.218 | 7.90 | 1.89286 | 20.4 | 0.6393 |
| 40 | −89.460 | 0.30 | | | |
| 41 | 187.115 | 8.77 | 1.43875 | 94.7 | 0.5340 |
| 42 | −24.905 | 1.71 | 2.00100 | 29.1 | 0.5997 |
| 43 | 170.253 | 0.20 | | | |
| 44 | 47.864 | 8.27 | 1.49700 | 81.5 | 0.5375 |
| 45 | −54.028 | (Variable) | | | |
| Image Plane | ∞ | | | | |

ASPHERIC DATA

1st Surface
K = 0.00000e+00 A 4 = −2.45588e−05 A 6 = −3.67611e−07 A 8 = 6.50001e−10
A10 = 5.55148e−12 A12 = 3.66117e−15 A14 = 1.47893e−19 A16 = −1.11709e−23
A 3 = 6.62720e−05 A 5 = 4.37863e−06 A 7 = 1.22001e−08 A 9 = −9.83386e−11
A11 = −1.82674e−13 A13 = −4.07328e−17 A15 = 1.37079e−21
3rd Surface
K = 0.00000e+00 A 4 = 1.95095e−05 A 6 = 1.65172e−07 A 8 = 1.89745e−10
A10 = 1.56723e−14
A 3 = −7.26428e−05 A 5 = −2.34782e−06 A 7 = −7.20838e−09 A 9 = −2.68491e−12
8th Surface
K = 0.00000e+00 A 4 = 1.08200e−05 A 6 = 3.36226e−08 A 8 = 5.96039e−12
A 3 = −4.57021e−05 A 5 = −7.80316e−07 A 7 = −7.25175e−10
19th Surface
K = 0.00000e+00 A 4 = −5.99251e−06 A 6 = −6.71902e−06 A 8 = −3.40305e−07
A10 = −2.73122e−09 A12 = −1.98857e−12
A 3 = 2.84076e−06 A 5 = 1.34577e−05 A 7 = 1.91719e−06 A 9 = 3.85362e−08
A11 = 1.11133e−10
27th Surface
K = 0.00000e+00 A 4 = −3.31332e−06 A 6 = 1.31899e−08 A 8 = 1.05154e−11
A 3 = −5.09297e−07 A 5 = −8.77617e−08 A 7 = −5.90945e−10

VARIOUS DATA
ZOOM RATIO 3.70

| | WIDE | MIDDLE | TELE |
|---|---|---|---|
| Focal Length | 13.20 | 30.03 | 48.78 |
| Fno | 2.73 | 2.73 | 3.07 |
| Half Angle of View (°) | 48.27 | 26.23 | 16.88 |
| Image Height | 14.80 | 14.80 | 14.80 |
| Overall Lens Length | 312.44 | 312.44 | 312.44 |
| BF | 40.00 | 40.00 | 40.00 |
| d18 | 1.52 | 31.94 | 44.97 |
| d23 | 37.30 | 10.62 | 3.97 |
| d26 | 0.00 | 5.70 | 5.01 |
| d28 | 16.70 | 7.27 | 1.58 |
| d45 | 40.00 | 40.00 | 40.00 |

LENS UNIT DATA

| Lens Unit | Starting Surface | Focal Length |
|---|---|---|
| 1 | 1 | 35.51 |
| 2 | 19 | −22.26 |
| 3 | 24 | −69.63 |
| 4 | 27 | 45.58 |
| 5 | 29 | 79.29 |

Table 1 summarizes values of inequalities (1) to (9) in numerical examples 1 to 7. The zoom lens according to each numerical example satisfy all of inequalities (1) to (9).

TABLE 1

| | | | Numerical Example | | | | | | |
|---|---|---|---|---|---|---|---|---|---|
| | | | 1 | 2 | 3 | 4 | 5 | 6 | 7 |
| Inequality | (1) | f1/fv | −0.79 | −0.94 | −0.70 | −0.82 | −0.98 | −0.92 | −1.60 |
| | (2) | β(N − 1)w | 3.3 | 14.8 | 3.0 | 5.4 | 4.6 | 4.2 | 6.6 |
| | (3) | LE/LR | 0.40 | 0.43 | 0.49 | 0.43 | 0.40 | 0.34 | 0.38 |
| | (4) | βrr | 0.30 | 0.32 | 0.24 | 0.38 | 0.38 | 0.28 | 0.38 |
| | (5) | β(N − 1)t/β(N − 1)w | 1.060 | 1.013 | 1.026 | 1.043 | 1.087 | 1.067 | 1.050 |
| | (6) | (f1 + bok1)/f1 | 3.2 | 3.0 | 3.5 | 3.0 | 3.2 | 3.9 | 2.5 |
| | (7) | f(N − 1)fV | −1.8 | −1.9 | −1.8 | −1.7 | −1.7 | −1.5 | −2.0 |
| | (8) | Lm/L | 0.18 | 0.15 | 0.18 | 0.15 | 0.18 | 0.16 | 0.16 |
| | (9) | f1/fw | 2.51 | 2.35 | 2.75 | 2.34 | 2.51 | 3.14 | 2.69 |
| | | f1 | 28.85 | 27.21 | 32.71 | 26.71 | 27.60 | 32.36 | 33.51 |
| | | fv | −36.48 | −28.97 | −46.54 | −32.69 | −28.19 | −35.06 | −22.26 |
| | | β(N − 1)w | 3.31 | 14.81 | 3.00 | 5.37 | 4.64 | 4.22 | 6.63 |
| | | LE | 41.07 | 41.06 | 51.46 | 41.34 | 41.40 | 34.89 | 41.07 |
| | | LR | 103.30 | 94.88 | 104.15 | 97.12 | 102.27 | 102.63 | 108.22 |
| | | βrr | 0.30 | 0.32 | 0.24 | 0.38 | 0.38 | 0.28 | 0.38 |
| | | β(N − 1)t | 3.51 | 15.00 | 3.08 | 5.60 | 5.04 | 4.51 | 6.96 |
| | | bok1 | 64.87 | 54.23 | 81.14 | 52.76 | 61.87 | 92.71 | 53.26 |
| | | f(N − 1) | 67.22 | 54.45 | 84.73 | 55.77 | 48.98 | 52.88 | 45.58 |
| | | Lm | 50.087 | 41.384 | 51.241 | 41.142 | 49.844 | 44.001 | 43.447 |
| | | L | 278.52 | 274.76 | 292.16 | 268.27 | 277.83 | 277.82 | 272.44 |
| | | fw | 11.479 | 11.570 | 11.886 | 11.438 | 10.995 | 10.300 | 13.200 |
| | | fv1 | −36.48 | −29.03 | 51.46 | −1804.98 | −53.93 | 329.63 | −22.26 |
| | | fv2 | — | — | — | −33.29 | −59.06 | −31.69 | — |

### Image Pickup Apparatus

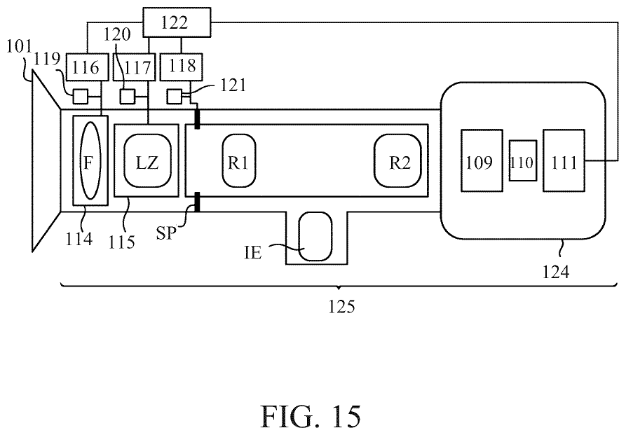

FIG. 15 schematically illustrates an image pickup apparatus including any one of the zoom lenses according to Examples 1 to 7 as an imaging optical system. In FIG. 15, reference numeral 101 denotes one of the zoom lenses according to Examples 1 to 7. Reference numeral 124 denotes a camera body. Reference numeral 125 denotes an image pickup apparatus configured by mounting the zoom lens 101 to the camera body 124. The zoom lens 101 is attachable to and detachable from the camera body 124. However, the zoom lens 101 may be integrated with the camera body 124.

The zoom lens 101 includes, in order from the object side to the image side, a first lens unit F, a zoom unit LZ, and an imaging lens unit R. The first lens unit F includes a focus (lens) unit that moves during focusing. The zoom unit LZ includes at least three or more (moving) lens units. An aperture stop SP, a lens unit R1, and a lens unit R2 are disposed on the image side of the zoom unit LZ. The image pickup apparatus 125 further includes an optical unit IE that can be inserted into and removed from the optical path between the lens units R1 and R2. Inserting the optical unit IE into space between the lens units R1 and R2 can change the focal length range of the zoom lens 101.

Reference numerals 114 and 115 denote drive mechanisms configured to move the first lens unit F and the lens units included in the zoom unit LZ along the optical axis. Reference numerals 116 to 118 denote motors configured to drive the drive mechanisms 114 and 115 and the aperture stop SP, respectively. Reference numeral 119 to 121 denote detectors configured to detect the position of the first lens unit F on the optical axis and the position of the lens units included in the zoom unit LZ, and detect the aperture diameter of the aperture stop SP, respectively.

In the camera body 124, reference numeral 109 denotes a glass block such as an optical filter, and reference numeral 110 denotes an image sensor configured to capture an object image formed by the zoom lens 101 (i.e., image the object through the zoom lens 101). The image sensor 110 includes a photoelectric conversion element such as a CCD sensor, a CMOS sensor, etc. Reference numerals 111 and 122 denote a camera CPU serving as a processing unit in the camera body 124 and a lens CPU serving as a processing unit in the zoom lens 101, respectively.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example according to the disclosure can provide a zoom lens that has a reduced size, a wide angle of view, and a high zoom magnification.

This application claims the benefit of Japanese Patent Application No. 2024-190407, which was filed on Oct. 30, 2024, and which is hereby incorporated by reference herein in its entirety.

What is claimed is:

1. A zoom lens comprising:
a plurality of lens units,
wherein the plurality of lens units include, in order from an object side to an image side,
a first lens unit with positive refractive power that does not move for zooming,
three or more movable lens units that move for zooming, and
an N-th lens unit with positive refractive power as a final lens unit,
wherein each distance between adjacent lens units changes during zooming,
wherein the three or more movable lens units include an (N−1)-th lens unit with positive refractive power, an (N−2)-th lens unit with negative refractive power, and one or more V lens units,
wherein the first lens unit includes a focus sub-lens unit that moves for focusing,
wherein the (N−1)-th lens unit is located closer to an image plane at a telephoto end than at a wide-angle end,
wherein the N-th lens unit includes a front sub-lens unit and a rear sub-lens unit arranged in this order from the object side via a widest air gap in the N-th lens unit, and
wherein the following inequalities are satisfied:
$$- 2.2 \leq \sum ( f 1 / fVi ) \leq - 0.4$$
$$2. \leq β ( N - 1 ) w \leq 18.5$$
$$0.3 \leq LE / LR \leq 0.7$$
$$- 0.8 \leq β rr \leq 0. 8$$
where f1 is a focal length of the first lens unit, fVi is a focal length of an i-th movable lens unit counted from the object side among the one or more V lens units, Σ(f1/fVi) is a sum of f1/fVi, β(N−1)w is a lateral magnification of the (N−1)-th lens unit at the wide-angle end, LE is a length on an optical axis of the widest air gap in the N-th lens unit, LR is a length on the optical axis from a surface closest to an object of the N-th lens unit to a surface closest to the image plane of the N-th lens unit, and βrr is a lateral magnification of the rear sub-lens unit at the wide-angle end.

2. The zoom lens according to claim 1, wherein the following inequality is satisfied:
$$1. 0 \leq β ( N - 1 ) t / β ( N - 1 ) w \leq 1.2$$
where β(N−1)t is a lateral magnification of the (N−1)-th lens unit at the telephoto end.

3. The zoom lens according to claim 1, wherein the following inequality is satisfied:
$$2. \leq ( f 1 + bok 1 ) / f 1 \leq 5.$$
where bok1 is a distance on the optical axis from a surface closest to the image plane of the first lens unit to a rear principal point of the first lens unit.

4. The zoom lens according to claim 1, wherein the following inequality is satisfied:
$$- 3. \leq \sum ( f ( N - 1 ) / fVi ) \leq - 0.5$$
where f(N−1) is a focal length of the (N−1)-th lens unit, and Σ(f(N−1)/fVi) is a sum of f(N−1)/fVi.

5. The zoom lens according to claim 1, wherein the one or more V lens units include one or more lens units with negative refractive power,
wherein Lm is a moving amount from the object side to the image side of a lens unit with a strongest negative refractive power among the one or more lens units with negative refractive power during zooming from the wide-angle end to the telephoto end, and
wherein the following inequality is satisfied:
$$0. < Lm / L \leq 0.3$$
where L is a length on the optical axis from the surface closest to the object of the first lens unit to the surface closest to the image plane of the N-th lens unit.

6. The zoom lens according to claim 1, wherein the following inequality is satisfied:
$$1. 0 \leq f 1 / fw \leq 5.$$
where fw is a focal length of the zoom lens at the wide-angle end.

7. The zoom lens according to claim 1, wherein the first lens unit includes:
a first sub-lens unit with negative refractive power that does not move for focusing and is disposed on the object side of the focus sub-lens unit,
a second sub-lens unit with positive refractive power as the focus sub-lens unit, and
a third sub-lens unit with positive refractive power that does not move for focusing and is disposed on the image side of the focus sub-lens unit.

8. The zoom lens according to claim 1, wherein the first lens unit includes six or more lenses.

9. The zoom lens according to claim 1, wherein the (N−1)-th lens unit moves monotonically toward the image side during zooming from the wide-angle end to the telephoto end.

10. The zoom lens according to claim 1, wherein the plurality of lens units include, in order from the object side to the image side:
the first lens unit,
a second lens unit with negative refractive power,
a third lens unit with negative refractive power,
a fourth lens unit with positive refractive power, and
a fifth lens unit as the final lens unit.

11. The zoom lens according to claim 1, wherein the plurality of lens units include, in order from the object side to the image side:
the first lens unit,
a second lens unit with negative refractive power,
a third lens unit with negative refractive power,
a fourth lens unit with negative refractive power,
a fifth lens unit with positive refractive power, and
a sixth lens unit as the final lens unit.

12. The zoom lens according to claim 1, wherein the plurality of lens units include, in order from the object side to the image side:
the first lens unit,
a second lens unit with positive refractive power,
a third lens unit with negative refractive power,
a fourth lens unit with negative refractive power,
a fifth lens unit with positive refractive power, and
a sixth lens unit as the final lens unit.

13. An image pickup apparatus comprising:
a zoom lens; and
an image sensor configured to image an object through the zoom lens,
where the zoom lens includes a plurality of lens units,
wherein the plurality of lens units include, in order from an object side to an image side,
a first lens unit with positive refractive power that does not move for zooming,
three or more movable lens units that move for zooming, and
an N-th lens unit with positive refractive power as a final lens unit,
wherein each distance between adjacent lens units changes during zooming,
wherein the three or more movable lens units include an (N−1)-th lens unit with positive refractive power, an (N−2)-th lens unit with negative refractive power, and one or more V lens units,
wherein the first lens unit includes a focus sub-lens unit that moves for focusing,
wherein the (N−1)-th lens unit is located closer to an image plane at a telephoto end than at a wide-angle end,
wherein the N-th lens unit includes a front sub-lens unit and a rear sub-lens unit arranged in this order from the object side via a widest air gap in the N-th lens unit, and
wherein the following inequalities are satisfied:
$$- 2.2 \leq \sum ( f 1 / fVi ) \leq - 0.4$$
$$2. \leq β ( N - 1 ) w \leq 18.5$$
$$0.3 \leq LE / LR \leq 0.7$$
$$- 0.8 \leq β rr \leq 0. 8$$
where f1 is a focal length of the first lens unit, fVi is a focal length of an i-th movable lens unit counted from the object side among the one or more V lens units, Σ(f1/fVi) is a sum of f1/fVi, β(N−1)w is a lateral magnification of the (N−1)-th lens unit at the wide-angle end, LE is a length on an optical axis of the widest air gap in the N-th lens unit, LR is a length on the optical axis from a surface closest to an object of the N-th lens unit to a surface closest to the image plane of the N-th lens unit, and βrr is a lateral magnification of the rear sub-lens unit at the wide-angle end.
